(19) United States
(12) Patent Application Publication
(10) Pub. No.: US 2005/0227860 A1
(43) Pub. Date: Oct. 13, 2005

(54) Polymerisation catalyst

(76) Inventors: Simon Green, Egham (GB); Hoyt C. Griffin, Aurora (GB); Brian Stephen Kimberley, Bouche Du Rhone (FR); Peter James Maddox, Staines (GB); Roger Uhrhammer, Aurora, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/512,282

(22) PCT Filed: Apr. 17, 2003
(86) PCT No.: PCT/GB03/01723

§ 371 Date: Oct. 22, 2004

(30) Foreign Application Priority Data
Apr. 24, 2002 (GB) 0209317.7

(51) Int. Cl. B01J 31/00

(52) U.S. Cl. 502/155; 502/150; 502/152; 502/162; 502/167; 502/168; 502/158; 502/117; 502/103; 526/351; 526/352; 526/348.5; 526/172

(57) ABSTRACT

A catalyst for polymerising 1-olefins, comprising (a) a tetradentate ligand I and II as illustrated in the specification wherein; D and D′ are phosphorus or nitrogen; Q and Q are bridging groups forming part of a ring; B is a bridging group between D and D′; R¹ and R⁹ are each independently a polar group or phenyl, naphthyl, anthryl, phenanthryl, triptycyl or a heteroaromatic ring; R⁵ to R⁸ are selected from hydrogen, halogen, hydrocarbyl, heterohydrocarbyl, NR′₂, PR′₂, OR′, SR′ or SiR′₃ where each R′ is independently selected from hydrogen, halogen, hydrocarbyl, heterohydrocarbyl, and any adjacent groups may be joined together to form a ring; in the case I, A and A′ are independently OH, 0⁻, SH, S⁻, NR″H, R″N⁻, PR″H or R″P⁻; and in the case II A and A′ are independently NH, N⁻, PH or P⁻, where R″ is defined as for groups R⁵ to R⁹ above; and R⁵ and R^{5′}, R⁶ and R^{6′}, or R⁷ and R⁸ may be joined together to form a ring; (b) a source of Group 3 to 10 transition metal or a lanthanide metal and optionally (c) an activator. Also claimed are transition metal complexes of the ligands and a process for (co)polymerising 1-olefins.

The present invention relates to transition metal complex compounds, to polymerisation catalysts based thereon and to their use in the polymerisation and copolymerisation of olefins.

The use of certain transition metal compounds to polymerise 1-olefins, for example, ethylene or propylene, is well established in the prior art. The use of Ziegler-Natta catalysts, for example, those catalysts produced by activating titanium halides with organometallic compounds such as triethylaluminium, is findamental to many commercial processes for manufacturing polyolefins. Over the last twenty or thirty years, advances in the technology have led to the development of Ziegler-Natta catalysts which have such high activities that olefin polymers and copolymers containing very low concentrations of residual catalyst can be produced directly in commercial polymerisation processes. The quantities of residual catalyst remaining in the produced polymer are so small as to render unnecessary their separation and removal for most commercial applications. Such processes can be operated by polymerising the monomers in the gas phase, or in solution, or in suspension in a liquid hydrocarbon diluent, or in a suspension of liquid monomer. Polymerisation of the monomers can be carried out in the gas phase (the “gas phase process”), for example by fluidising under polymerisation conditions a bed comprising the target polyolefin powder and particles of the desired catalyst using a fluidising gas stream comprising the gaseous monomer. In the so-called “solution process” the (co)polymerisation is conducted by introducing the monomer into a solution or suspension of the catalyst in a liquid hydrocarbon diluent under conditions of temperature and pressure such that the produced polyolefin forms as a solution in the hydrocarbon diluent. In the “slurry process” the temperature, pressure and choice of diluent are such that the produced polymer forms as a suspension in the liquid hydrocarbon diluent. These processes are generally operated at relatively low pressures (for example 10-50 bar) and low temperature (for example 50 to 150° C.).

In recent years there have been many advances in the production of polyolefin homopolymers and copolymers due to the introduction of metallocene catalysts. Metallocene catalysts offer the advantage of potentially higher activity than traditional Ziegler catalysts and are usually described as catalysts which are single site in nature. There have been developed several different families of metallocene complexes. In earlier years catalysts based on bis (cyclopentadienyl) metal complexes were developed, examples of which may be found in EP 129368 or EP 206794. More recently complexes having a single or mono cyclopentadienyl ring have been developed. Such complexes have been referred to as ‘constrained geometry’ complexes and examples of these complexes maybe found in EP 416815 or EP 420436.

However, metallocene catalysts of the type described above suffer from a number of disadvantages, for example, high sensitivity to impurities when used with commercially available monomers, diluents and process gas streams, the need to use large quantities of expensive alumoxanes to achieve high activity, and difficulties in putting the catalyst on to a suitable support.

There has been much work in recent years to find alternatives to metallocene catalysts for olefin polymerisation.

EP 874005 discloses imine complexes of the following formula, in which M is a transition metal from Group 3 to 11 of the Periodic Table, for the polymerisation of olefins.

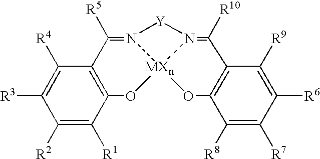

EP 1008595 discloses as olefin polymerisation catalysts imine complexes of the general formula

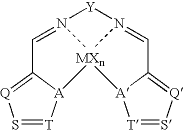

where A and A′ are independently nitrogen or phosphorus, and Q, Q′, S, S′, T and T′ are independently N or P, or CR.

EP 950667 discloses as olefin polymerisation catalysts amine complexes of the general formula

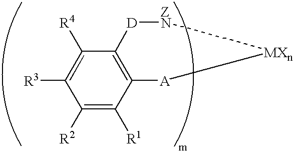

where A can be O, S or NR, D is an alkylene group, m is 1 to 3, and Z is a group bonded to N which may optionally be linked to another ligand when m is greater than 1. In one example, X is ═N—, forming part of an aromatic ring and datively bound to M, m is 2 and Z is an alkylene linkage to the nitrogen on the other ligand attached to M.

Kol, M. et al, Chem. Commun., (2000), pp. 379-380) discloses that a complex of the formula (A)

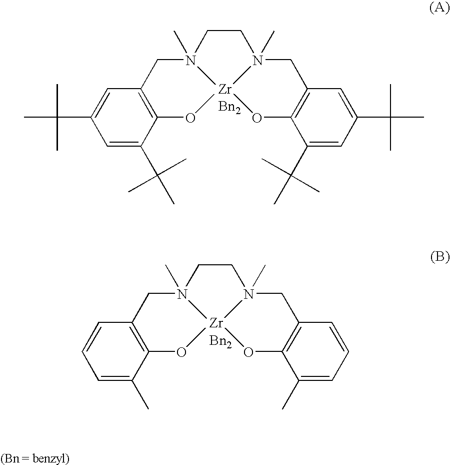

may be used to polymerise 1-hexene but with low activity. Busico, V. et al, Macromol. Rapid Commun., (2001), Vol 22, Issue 22, pp. 1405 -1410) also discloses that the bridged complexes of the form (A) or (B) may be used to polymerise propylene but also with very low activity.

An object of the present invention is to provide a novel catalyst suitable for polymerising and oligomerising monomers, for example, olefins such as α-olefins containing from 2 to 20 carbon atoms, and especially for polymnerising ethylene alone, propylene alone, or for copolymerising ethylene or propylene with other 1-olefins such as C₂₋₂₀ α-olefins or polar α-olefins.

We have made the surprising discovery that certain bridged complexes with suitably placed aryl or polar substituents are significantly more active olefin polymerisation catalysts than those disclosed in EP 0 950 667 A2, or described in the aforementioned publications by Kol or Busico. Certain such bridged complexes show high reactivity to co-monomers such as 1-hexene, comparable to the metallocene catalysts described above. Propylene polymerisation can also be achieved, and a further advantage of some of these catalysts is that they polymerise ethylene to give products which show surprisingly high levels of long chain branching in the polymer chain.

Accordingly in its broadest aspect, the present invention provides a catalyst for the polymerisation of 1-olefins, comprising

(a) a ligand of Formula (C) or Formula (II) 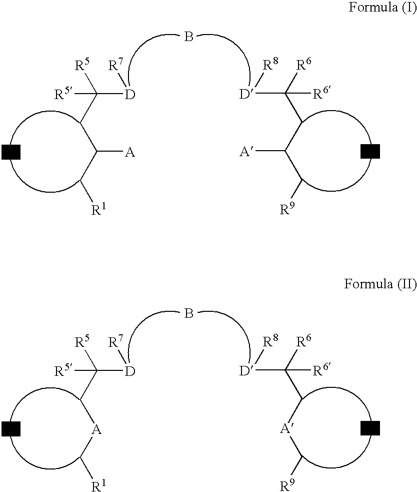
wherein; D and D′ are each independently phosphorus or nitrogen atoms; Q and Q′ are each independently bridging groups forming part of a ring; B is a bridging group between D and D′; R¹ and R⁹ are each independently a polar group or phenyl, naphthyl, anthryl, phenanthryl, triptycyl or a heteroaromatic ring, any of which may be further substituted; R⁵ to R⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups may be joined together to form a ring; in the case of Formula (I), A and A′ independently OH, O⁻, SH, S⁻, NR″H, R″N, PR″H or R″P⁻; and in the case of formula (II) A and A′ are independently NH, N⁻, PH or P⁻, where R″ is defined as for groups R⁵ to R⁹ above; and R⁵ and R^{5′}, R⁶ and R^{6′} or R⁷ and R⁸ may be joined together to form a ring;
(b) a source of transition metal from Group 3 to 10 of the Periodic Table or a lanthanide metal and optionally
(c) an activator.

The terms “anthryl”, “phenanthryl” and “triptycyl” are the groups derived by removal of a hydrogen atom from, respectively, anthracene, phenanthrene and triptycene. The groups have also been referred to in the art as “anthracenyl”, “phenanthrenyl” and “triptycenyl”.

By “further substituted” is meant that one or more of the hydrogen atoms of the anthryl, phenanthryl or triptycyl groups can be replaced by any atom or group that does not adversely affect the catalytic properties of the complex or activated complex. Examples of such atoms or groups are those independently selected from halo, for example, chloro, bromo, iodo, fluoro; hydrocarbyl, for example C₁ to C₂₀, alkyl, aryl, alkyl substituted aryl group, or aryl substituted alkyl group; C₁ to C₂₀ alkoxy, for example methoxy, ethoxy, propoxy, butoxy, phenoxy; C₁ to C₂₀ secondary or tertiary amine, for example R—NH— or RR′N—; RS— or R₃Si—; wherein R and R′ are independently C₁ to C₂₀ allyl, aryl, alkaryl or aralkyl. Such atoms or groups can thus contain C₂ to C₁₀ if desired. Thus, if desired, one or more of the benzene rings of the anthryl, phenanthryl or triptycyl groups can be fused to one or more other aromatic rings.

The “hydrocarbyl, substituted hydrocarbyl, heterohydrocarbyl and substituted heterohydrocarbyl groups” referred to above and throughout this specification are monovalent groups which are preferably selected from (i) aliphatic hydrocarbon, (ii) alicyclic hydrocarbon, (iii) aromatic hydrocarbon, (iv) alkyl substituted aromatic hydrocarbon (v) heterocyclic groups and (vi) heterosubstituted derivatives of said groups (i) to (v). These defined groups preferably contain 1 to 30, more preferably 2 to 20, most preferably 2 to 12 carbon atoms. Examples of suitable aliphatic hydrocarbon groups are methyl, ethyl, ethylenyl, isopropyl and tertbutyl. Examples of suitable alicyclic hydrocarbon groups are adamantyl, cyclopentyl and cyclohexyl. Examples of suitable aromatic hydrocarbon groups are phenyl, biphenyl, naphthyl, phenanthrenyl and anthacenyl. Examples of suitable alkyl substituted aromatic hydrocarbon groups are benzyl, tolyl, mesityl, 2,6-diisopropylphenyl and 2,4,6-triisopropyl. Examples of suitable heterocyclic groups are 2-pyridinyl, 3-pyridinyl, 2-thiophenyl, 2-furanyl, 2-pyrrolyl, 2-quinolinyl. Suitable substituents for forming heterosubstituted derivatives of said groups (i) to (v) are, for example, chloro, bromo, fluoro, iodo, nitro, amino, cyano, ether, hydroxyl and silyl, methoxy, ethoxy, phenoxy (i.e. —OC₆H₅), tolyloxy (i.e. —OC₆H₄(CH₃)), xylyloxy, mesityloxy, dimethylamino, diethylamino, methylethylamino, thiomethyl, thiophenyl and trimethylsilyl. Examples of suitable heterosubstituted derivatives of said groups (i) to (v) are 2-chloroethyl, 2-bromocyclohexyl, 2-nitrophenyl, 4-ethoxyphenyl, 4-chloro-2-pyridinyl, 4-dimethylaminophenyl and 4-methylaminophenyl.

A “polar group” is defined as a group bonded to the rest of the ligand through an atom which has an electronegativity different to carbon. For the avoidance of doubt, the term as used throughout this specification is deemed to mean an atom or group connected through B, C, N, O, F, Al, Si, P, S, Cl, Ga, Ge, As, Se, Br, In, Sn, Te, I and Pb, with the proviso that if the atom is a single carbon atom, it bears no substituents other than halogen substituents and if the atom comprises two or more carbon atoms one of which is directly linked into the ligand, the additional carbon atom(s) “alpha” to the first carbon bear no substituents other than halogen substituents

Preferably such halogen substituents are F or Cl, most preferably F. Examples of carbon linked polar groups are C₆F₅, CF₃, CF₂CF₃, C₆Cl₅, 2,6-C₆F₂H₃).

Examples of noncarbon linked polar groups are fluorine, chlorine, bromine, or iodine, alkoxide or aryloxide (e.g. OMe, OPh, OtBu, OiPr, OEt, O-octyl, OSiMe₃, OR′), thio alkoxide or thio aryloxide (e.g. SMe, SPh, StBu, SiPr, SEt, SR′), sulfonates (e.g. SO₂-p-toluene, SO₂Me, SO₂CF₃, SO₂R′), sulfamate (e.g. SO₂NR′₂), amino (e.g. NMe₂, NEt₂ NEtiPr, NiPr₂, NPh₂, N-pyrrolidine, N-pyrrole, N-piperdine, NtBu₂, N(SiMe₃)2, NR′₂), phosphino (e.g. PMe₂, PPh₂, PEt₂, PR′₂), phosphite (e.g. P(OMe)₂, P(OPh)₂, P(OR′)₂, PO(OR′)₂), silyl (e.g. SiMe₃, SiEt₃, SitBuMe₂, SiR′₃), alkoxysilyl (e.g. SiMe(OMe)₂, SiR′n(OR′)₃₋ₙ), aminosilyl (e.g. SiR′ₙ(NR′₂)₃₋ₙ), N-alkoxyamino (e.g. NR′(OR′)), NO₂, amide (e.g. NR′COR′), borane (e.g. BR′₂), borate anion (e.g. B(C₆F₅)₃—, BR′₃—), boronic acid ester (e.g. B(OR′)₂), boronic acid amide (e.g. B(NR₂)₂), ammonium cation (e.g. NR′₃⁺), phosphonium cation (e.g. PR′₃⁺), where R′ is defined above. It will be readily apparent to the man skilled in the art that a multitude of different groups having similar characteristics to those listed above will be equally suitable for forming the ligand used in the catalyst of the present invention. Especially preferred polar groups are those wherein the atom, or the link atom into the ligand, is selected from N, O, P and S.

A further aspect of the invention provides a compound per se having the Formula (I) or (II) above, wherein the substituents are defined as above except that R¹ and R⁹ are each independently anthryl, phenanthryl or triptycyl only, each of which may optionally be further substituted.

In a second aspect, the present invention provides a catalyst for the polymerisation of 1-olefins, comprising a metal complex having the Formula (Ia) or (IIa) 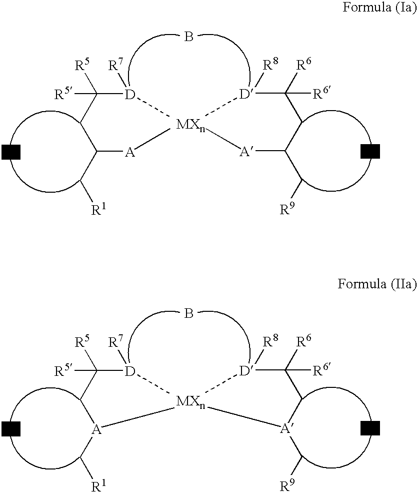
wherein M is a transition metal from Group 3 to 10 of the Periodic Table or a lanthanide; Q and Q′ are each independently bridging groups forming part of a ring; B is a bridging group between D and D′; X represents an atom or group covalently or ionically bonded to M; n is from 1 to 5; D and D′ are each independently nitrogen or phosphorus; R¹ and R⁹ are each independently a polar group or phenyl, naphthyl, anthryl, phenanthryl, or triptycyl or a heteroaromatic ring, any of which may be further substituted; R⁵ to R⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups may be joined together to form a ring; in the case of formula (Ia) A and A′ are independently O, S, NR″ or PR″ and are covalently or ionically bonded to M, R″ is as defined as for R⁵ to R⁸ above; in the case of formula (IIa) A and A′ are independently N or P and are covalently or ionically bonded to M; R⁵ and R^{5′}, R⁶ and R^{6′} or R⁷ and R⁸ may be joined together to form a ring; and (b) an activator.

A further aspect of the invention provides a complex per se having the Formula (Ia) or (IIa) above but where R¹ and R⁹ are each independently anthryl, phenanthryl or triptycyl only, each of which may optionally be further substituted. The meaning of the term “further substituted” in relation to the anthryl, phenanthryl or triptycyl groups has been defined above.

Preferably the ligands have the formulae (III) and (IV) 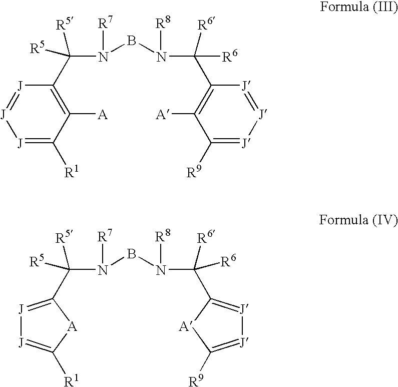
wherein A, A′, B, R¹ and R⁵ to R⁹ are as defined for Formulae (I) and (II) above, J and J′ are each independently N, P or C, with the proviso that for Formula (III), at least one J and one J′ are CR¹⁰, and where each R¹⁰ is defined as being independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups R¹⁰ may be joined together to form a ring. Any pair of R groups from R¹ and R⁵ to R¹⁰ which are bonded to the same, or adjacent carbon atoms may be joined together to form a ring. R⁷ and R⁸ may also be linked to form a ring.

Each of the nitrogen atoms in Formulae (III) and (IV) may be (but are not restricted to being) coordinated to the metal M by a “dative” bond, i.e. a bond formed by donation of a lone pair of electrons from the nitrogen atom. The remaining bonds on each nitrogen atom are covalent bonds formed by electron sharing between the nitrogen atoms and the organic ligand as shown in the defined formula for the transition metal complex illustrated above.

When R¹ and R⁹ are “polar groups”, it is preferred that those groups be in the ortho position relative to A and A′. However, such single polar groups are not necessarily in the ortho position. In the situation that there may be two or more polar groups on at least one of the rings, it is preferred that (1) there is at least one polar group in the ortho position and at least one polar group in a nonortho position, preferably a para position; or 2) there are two or more polar groups on the ring neither (all) of which are not in the ortho position.

The invention also includes within its scope complexes comprising the ligands of Formulae (III) and (IV) complexed with MXₙ, where M, X, n and A and A′ are as defined for Formulae (Ia) and (IIa) above.

The bridging group B in all the formulae above is preferably hydrocarbyl, heterohydrocarbyl, aromatic, heteroaromatic, ferrocenyl or comprises NR′, PR′ or SiR′₂ where in each case R′ is independently selected from hydrogen, halogen, hydrocarbyl, substituted hydrocarbyl, heterohydrocarbyl and substituted heterohydrocarbyl. Preferably the bridging group B comprises one of the structures shown below: 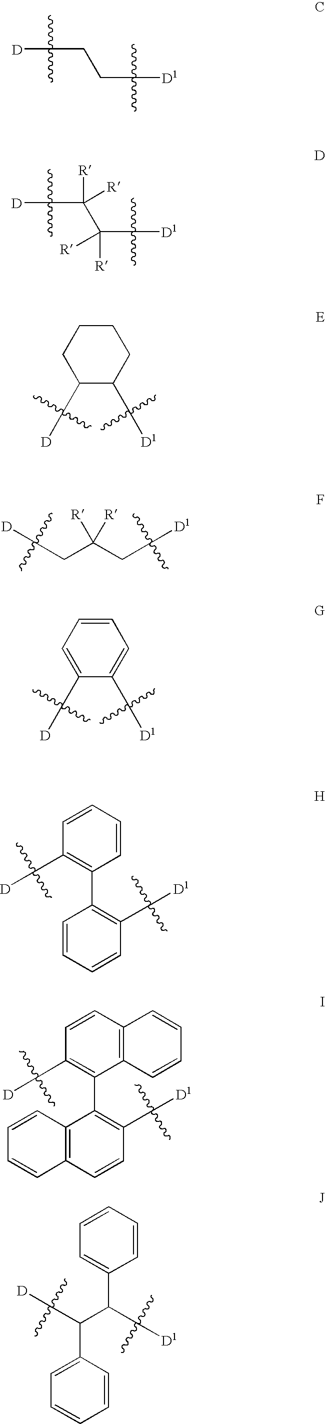 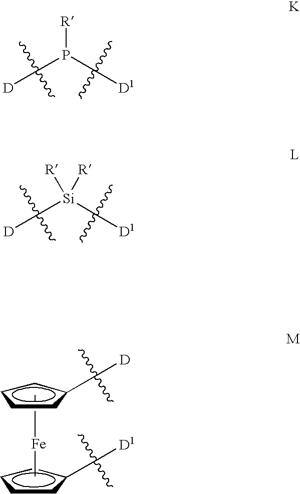
where the R′ groups are each independently defined as above. Preferably D and D¹ in Formulae C to M are both nitrogen atoms.

More preferably the bridging group B is the structure C, D, E, F or G above, especially when both the atoms D and D¹ are nitrogen.

A particularly preferred ligand has the Formula (V) 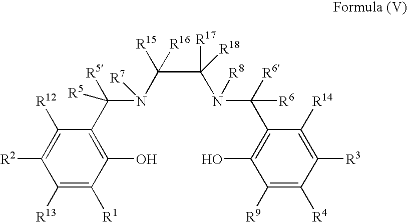
wherein R¹ and R⁵ to R⁹ are as defined above; and R² to R⁴ and R¹² to R¹⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R¹ is independently selected from hydrogen, halogen, hydrocarbyl, substituted hydrocarbyl, heterohydrocarbyl and substituted heterohydrocarbyl, and any adjacent groups may be joined together to form a ring. In the corresponding preferred complex with MXₙ where M, X and n are as previously defined, the two OH groups are replaced by O covalently bonded to M.

Examples of preferred ligands within the scope of Formula (V) are shown below: 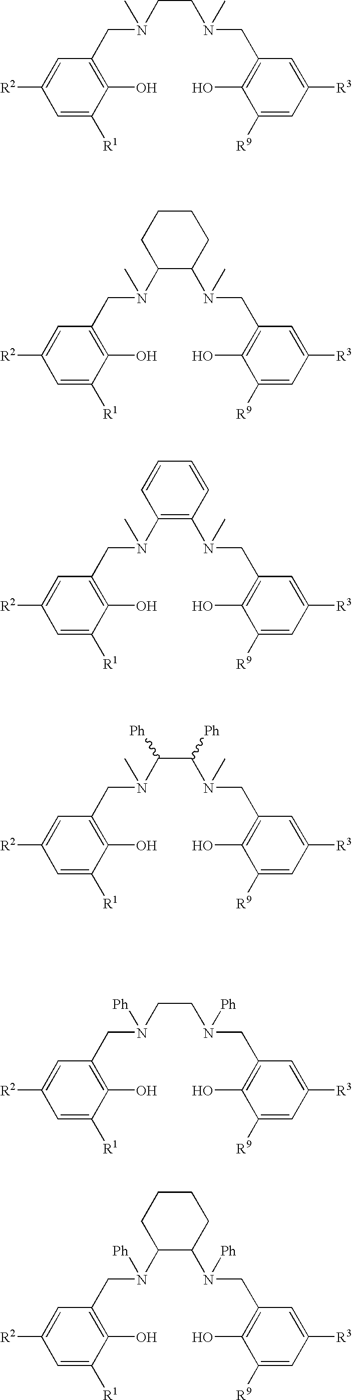 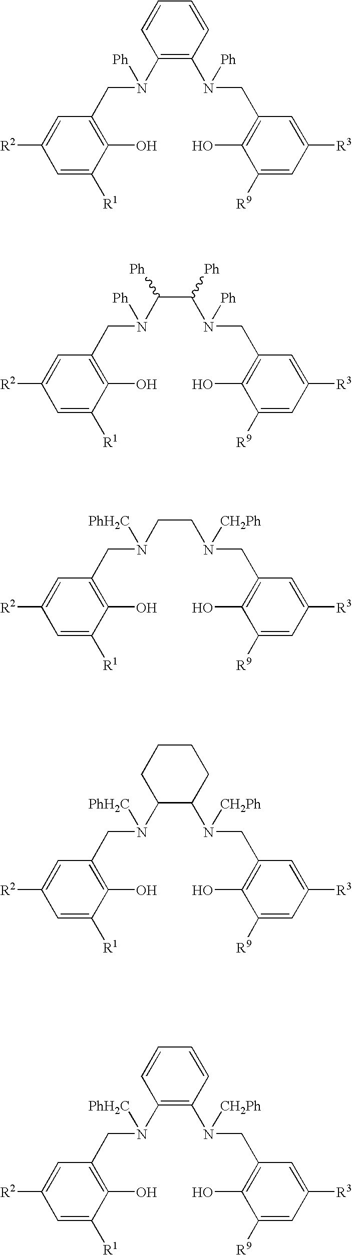 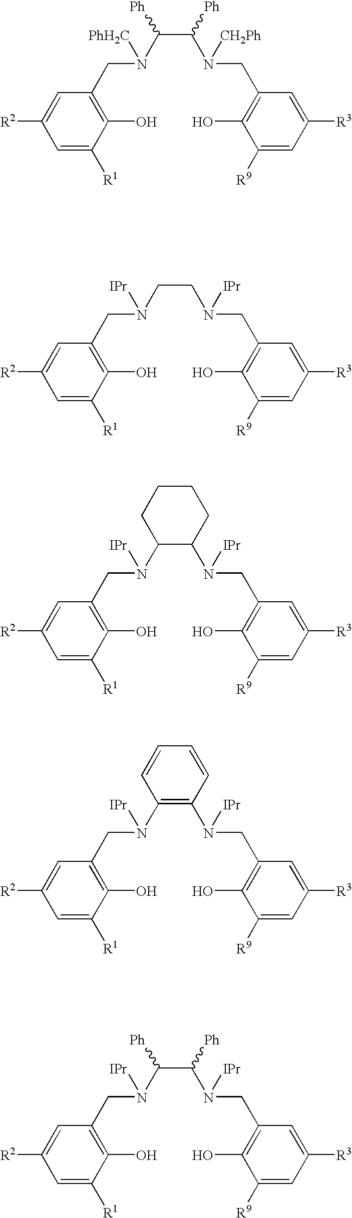 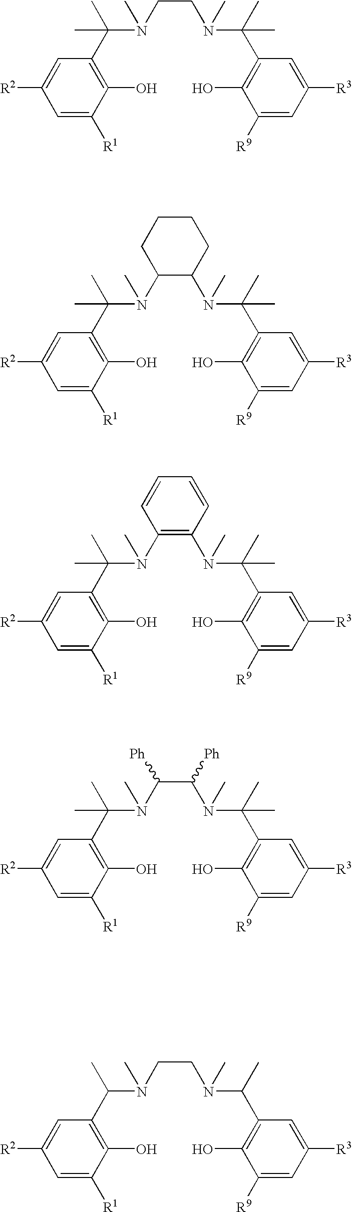 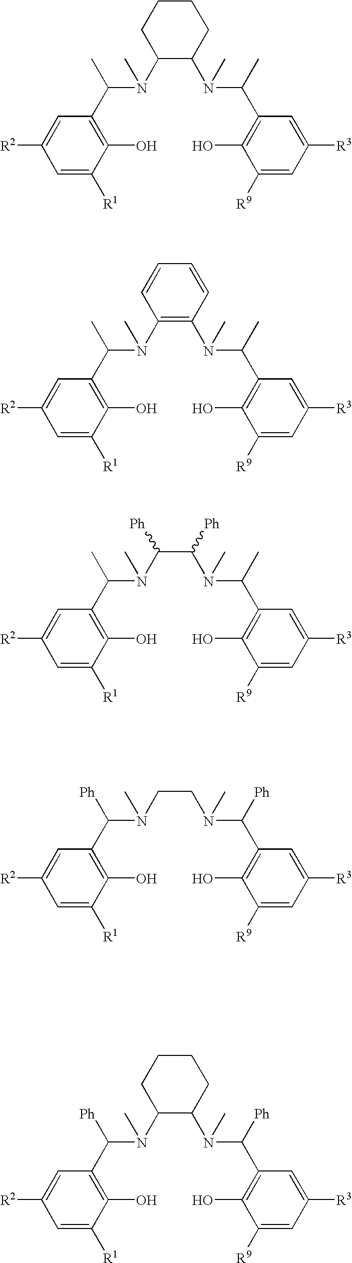 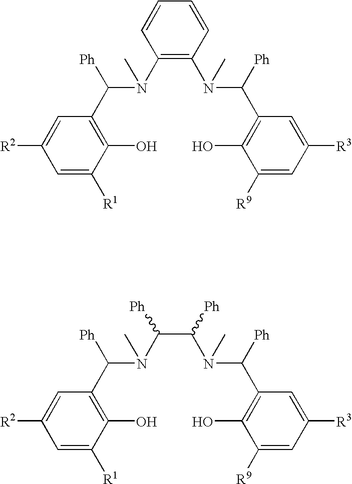
where R² and R³ are preferably each independently hydrogen, hydrocarbyl, heterohydrocarbyl, halogen, methoxy or NO₂ ,and R¹ and R⁹ are each independently as defined above. Particularly preferred are the above structures where R²=R³=hydrogen and R¹ and R⁹ are each independently phenyl, naphthyl, anthryl or triptycyl, any of which may be further substituted. Also more preferable are the structures above where R²=R³=hydrogen or halogen and R¹=R⁹=halogen.

Preferably in all the formulae described above, M (the transition metal) is Ti[II], Ti[III], Ti[IV], Fe[II], Fe[III], Co[II], Co[III], Ni[II], Cr[II], Cr[III], Mn[II], Mn[III], Mn[IV], Ta[II], Ta[III], Ta[IV], Rh[II], Rh[III], Y[II], Y[III], Sc[II], Sc[III], Ru[II], Ru[III], Ru[IV], Pd[II], Zr[II], Zr[III], Zr[IV], Hf[II], Hf[III], Hf[IV], V[II], V[III], V[IV], Nb[II], Nb[III], Nb[IV] or Nb[V] or lanthanide metal. More preferably the metal M is Ti[II], Ti[III], Ti[IV], Zr[II], Zr[III], Zr[IV], Hf[II], Hf[III], Hf[IV] or a lanthanide metal.

In all the formulae described above, R¹ and R⁹ are preferably each independently methoxy, isopropoxy, NO₂, aryl or halogen; more preferably fluorine, chlorine or bromine, or methoxy or substituted or unsubstituted phenyl, naphthyl, phenanthryl, triptycyl or anthryl, the substituents, if any, being one or more C₁-C₄ alkyl groups.

Also preferred for the groups R¹ and R⁹ are the following Structures A1 and A2: 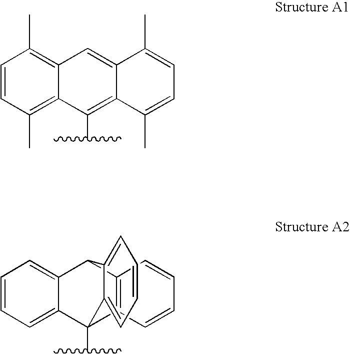
Especially preferred ligands of the invention are shown below:

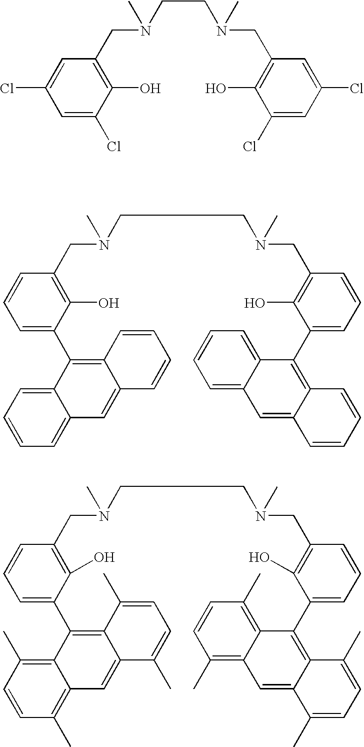

Particularly preferred complexes are those of the above ligands with MXₙ, where M═Zr, Ti, Hf or lanthanide, X is alkyl or halogen, and n is from 1 to 5.

The atom or group represented by X in the above complexes can be, for example, selected from halide, sulphate, nitrate, thiolate, thiocarboxylate, BF₄⁻, PF₆⁻, hydride, hydrocarbyloxide, carboxylate, hydrocarbyl, substituted hydrocarbyl and heterohydrocarbyl, or β-diketonates. Examples of such atoms or groups are chloride, bromide, methyl, ethyl, propyl, butyl, octyl, decyl, phenyl, benzyl, methoxide, ethoxide, isopropoxide, tosylate, triflate, formate, acetate, phenoxide and benzoate. Preferred examples of the atom or group X are halide, for example, chloride, bromide; hydride; hydrocarbyloxide, for example, methoxide, ethoxide, isopropoxide, phenoxide; carboxylate, for example, formate, acetate, benzoate; hydrocarbyl, for example, methyl, ethyl, propyl, butyl, octyl, decyl, phenyl, benzyl; substituted hydrocarbyl; heterohydrocarbyl; tosylate; and triflate. Preferably X is selected from halide, hydride and hydrocarbyl. Chloride is particularly preferred. Options for MXₙ include MX₂ where X is a halogen, or a hydrocarbyl group, for example benzyl. Optionally MX₂ may contain one X group which is a halogen and one X group which is a hydrocarbyl group.

The complexes of the second aspect of the invention may be used as catalysts for the polymerisation of 1-olefins, in conjunction with an activator compound.

The activator compound for all the catalysts of the present invention is suitably selected from organoaluminium compounds and hydrocarbylboron compounds. Suitable organoaluminium compounds include compounds of the formula AlR₃, where each R is independently C₁C₁₂ alkyl or halo. Examples include trimethylaluminium (TMA), triethylaluminium (TEA), triisobutylaluminium (TIBA), tri-n-octylaluminium, methylaluminium dichloride, ethylaluminium dichloride, dimethylaluminium chloride, diethylaluminium chloride, ethylaluminiumsesquichloride, methylaluminiumsesquichloride, and alumoxanes. Alumoxanes are well known in the art as typically the oligomeric compounds which can be prepared by the controlled addition of water to an alkylaluminium compound, for example trimethylaluminium. Such compounds can be linear, cyclic, polycyclic or mixtures thereof. Commercially available alumoxanes are generally believed to be mixtures of linear and cyclic compounds. The cyclic alumoxanes can be represented by the formula [R¹⁶AlO]ₛ and the linear alumoxanes by the formula R¹⁷(R¹⁸AlO)ₛ wherein s is a number from about 2 to 50, and wherein R¹⁶, R¹⁷, and R¹⁸ represent hydrocarbyl groups, preferably C₁ to C₆ alkyl groups, for example methyl, ethyl or butyl groups. Alkylalumoxanes such as methylalumoxane (MAO) are preferred.

Mixtures of alkylalumoxanes and trialkylaluminium compounds can also be used, such as MAO with TMA or TDBA. lIn this context it should be noted that the term “alkylalumoxane” as used in this specification includes alkylalumoxanes available commercially which may contain a proportion, typically about 10 wt %, but optionally up to 50wt %, of the corresponding trialkylaluminium; for instance, commercial MAO usually contains approximately 10 wt % trimethylaluminium (TMA), whilst commercial MMAO contains both TMA and TIBA. Quantities of alkylalumoxane quoted herein include such trialkylaluminium impurities, and accordingly quantities of trialkylaluminium compounds quoted herein are considered to comprise compounds of the formula AlR₃ additional to any AlR₃ compound incorporated within the alkylalumoxane when present.

Examples of suitable hydrocarbylboron compounds are boroxines, trimethylboron, triethylboron, dimethylphenylammonium tetra(phenyl)borate, trityl tetra(phenyl)borate, triphenylboron, dimethylphenylammonium tetrakis(pentafluorophenyl)borate, sodium tetrakis[(bis-3,5-trifluoromethyl)phenyl]borate, H⁺(OEt₂) tetrakis[(bis-3,5-trifluoromethyl)phenyl]borate, trityl tetrakis(pentafluorophenyl)borate and tris(pentafluorophenyl)boron.

In the preparation of the catalysts of the present invention the quantity of activating compound selected from organoaluminium compounds and hydrocarbylboron compounds to be employed is easily determined by simple testing, for example, by the preparation of small test samples which can be used to polymerise small quantities of the monomer(s) and thus to determine the activity of the produced catalyst. It is generally found that the quantity employed is sufficient to provide 0.1 to 20,000 atoms, preferably 1 to 2000 atoms of aluminium or boron per atom of metal M in the compounds of Formula (Ia) or Formula (IIa).

An alternative class of activators comprise salts of a cationic oxidising agent and a noncoordinating compatible anion. Examples of cationic oxidising agents include:ferrocenium, hydrocarbyl-substituted ferrocenium, Ag⁺, or Pb²⁺. Examples of non-coordinating compatible anions are BF₄⁻, SbF₆⁻, PF₆⁻, tetrakis(phenyl)borate and tetrakis(pentafluorophenyl)borate.

A further aspect of the present invention provides a polymerisation catalyst system comprising (1) a complex as hereinbefore defined, (2) an activating quantity of at least one activator compound as defined above, and (3) a neutral Lewis base.

Neutral Lewis bases are well known in the art of Ziegler-Natta catalyst polymerisation technology. Examples of classes of neutral Lewis bases suitably employed in the present invention are unsaturated hydrocarbons, for example, alkenes (other than 1-olefins) or alkynes, primary, secondary and tertiary amines, amides, phosphoramides, phosphines, phosphites, ethers, thioethers, nitrites, carbonyl compounds, for example, esters, ketones, aldehydes, carbon monoxide and carbon dioxide, sulphoxides, sulphones and boroxines. Although 1-olefins are capable of acting as neutral Lewis bases, for the purposes of the present invention they are regarded as monomer or comonomer 1-olefins and not as neutral Lewis bases per se. However, alkenes which are internal olefins, for example, 2-butene and cyclohexene are regarded as neutral Lewis bases in the present invention. Preferred Lewis bases are tertiary amines and aromatic esters, for example, dimethylaniline, diethylaniline, tributylamine, ethylbenzoate and benzylbenzoate. In this particular aspect of the present invention, components (1), (2) and (3) of the catalyst system can be brought together simultaneously or in any desired order. However, if components (2) and (3) are compounds which interact together strongly, for example, form a stable compound together, it is preferred to bring together either components (1) and (2) or components (1) and (3) in an initial step before introducing the final defined component. Preferably components (1) and (3) are contacted together before component (2) is introduced. The quantities of components (1) and (2) employed in the preparation of this catalyst system are suitably as described above in relation to the catalysts of the present invention. The quantity of the neutral Lewis Base [component (3)] is preferably such as to provide a ratio of component (1):component (3) in the range 100:1 to 1:1000, most preferably in the range 1:1 to 1:20. Components (1), (2) and (3) of the catalyst system can be brought together, for example, as the neat materials, as a suspension or solution of the materials in a suitable diluent or solvent (for example a liquid hydrocarbon), or, if at least one of the components is volatile, by utilising the vapour of that component. The components can be brought together at any desired temperature. Mixing the components together at room temperature is generally satisfactory. Heating to higher temperatures e.g. up to 120° C. can be carried out if desired, e.g. to achieve better mixing of the components. It is preferred to carry out the bringing together of components (1), (2) and (3) in an inert atmosphere (e.g. dry nitrogen) or in vacuo. If it is desired to use the catalyst on a support material (see below), this can be achieved, for example, by preforming the catalyst system comprising components (1), (2) and (3) and impregnating the support material preferably with a solution thereof, or by introducing to the support material one or more of the components simultaneously or sequentially. If desired the support material itself can have the properties of a neutral Lewis base and can be employed as, or in place of, component (3). An example of a support material having neutral Lewis base properties is poly(aminostyrene) or a copolymer of styrene and aminostyrene (i.e. vinylaniline).

The catalysts of the present invention can if desired comprise more than one of the defined compounds. Alternatively, the catalysts of the present invention can also include one or more other types of transition metal compounds or catalysts, for example, nitrogen containing catalysts such as those described in WO 99/12981, GB 9903402.7 or WO 02/04119. Examples of such other catalysts include 2,6-diacetylpyridinebis(2,4,6trinethyl anil)FeCl₂.

The catalysts of the present invention can also include one or more other types of catalyst, such as those of the type used in conventional ZieglerNatta catalyst systems, metallocenebased catalysts, monocyclopentadienyl or constrained geometry based catalysts, or heat activated supported chromium oxide catalysts (e.g. Phillipstype catalyst).

The catalysts of the present invention can be unsupported or supported on a support material, for example, silica, alumina, MgCl₂ or zirconia, or on a polymer or prepolymer, for example polyethylene, polypropylene, polystyrene, or poly(aminostyrene).

If desired the catalysts can be formed in situ in the presence of the support material, or the support material can be preimpregnated or premixed, simultaneously or sequentially, with one or more of the catalyst components. The catalysts of the present invention can if desired be supported on a heterogeneous catalyst, for example, a magnesium halide supported Ziegler Natta catalyst, a Phillips type (chromium oxide) supported catalyst or a supported metallocene catalyst. Formation of the supported catalyst can be achieved for example by treating the transition metal compounds of the present invention with alumoxane in a suitable inert diluent, for example a volatile hydrocarbon, slurrying a particulate support material with the product and evaporating the volatile diluent. The produced supported catalyst is preferably in the form of a free flowing powder. The quantity of support material employed can vary widely, for example from 100,000 to 1 grams per gram of metal present in the transition metal compound.

The present invention further provides a process for the polymerisation and copolymerisation of 1-olefins, comprising contacting the monomeric olefin under polymerisation conditions with the polymerisation catalyst or catalyst system of the present invention. The process may comprise the steps of:

a) preparing a prepolymerbased catalyst by contacting one or more 1-olefins with a catalyst system, and

b) contacting the prepolymerbased catalyst with one or more 1-olefins,

wherein the catalyst system is as defined above.

The present invention also encompasses as another aspect the use of a complex as defined above as a catalyst for the polymerisation of 1-olefins.

In the text hereinbelow, the term “catalyst” is intended to include “catalyst system” as defined previously and also “prepolymerbased catalyst” as defined above.

The catalysts of the invention may be preformed, or may be formed in-situ by adding the components, including the activator, to the polymerisation reactor.

The polymerisation conditions can be, for example, solution phase, slurry phase, gas phase or bulk phase, with polymerisation temperatures ranging from −100° C. to +300° C., and at pressures of atmospheric and above, particularly from 140 to 4100 kPa. If desired, the catalyst can be used to polymerise ethylene under high pressure/high temperature process conditions wherein the polymeric material forms as a melt in supercritical ethylene. Preferably the gas phase polymerisation is conducted under fluidised bed or stirred bed conditions.

Suitable monomers for use in the polymerisation process of the present invention are, for example, C₂₋₂₀ α-olefins, specifically ethylene, propylene, 1-butene, 1-pentene, 1-hexene, 4-methylpentene-1, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, and 1-eicosene. Other monomers include methyl methacrylate, methyl acrylate, butyl acrylate, acrylonitrile, vinyl acetate, and styrene. Preferred monomers for homopolymerisation processes are ethylene and propylene.

The present invention is especially useful for copolymerising ethylene with one or more C₃ to C₈ 1olefins. Thus a preferred process in accordance with the present invention comprises copolymerising ethylene with one or more other 1-olefins in the presence of the transition metal complex of the present invention optionally in the presence of an activator. The quantity of the one or more other 1olefins is preferably in the range 0.1 to 50 weight % based on the total weight of monomer. Preferred monomers are hexane-1, 4-methyl-penten-1, butene-1 and n-octene-1.

The catalysts and process of the invention can also be used for copolymerising ethylene and propylene with each other or for copolymerising ethylene or propylene with other 1-olefins such as 1-butene, 1-hexene, 4-methylpentene-1, and 1-octene, or with other monomeric materials, for example, methyl methacrylate, methyl acrylate, butyl acrylate, acrylonitrile, vinyl acetate, and styrene. Mixtures of two or more co-monomers may be copolymerised with ethylene or propylene if desired.

Irrespective of the polymerisation or copolymerisation technique employed, polymerisation or copolymerisation is typically carried out under conditions that substantially exclude oxygen, water, and other materials that act as catalyst poisons. Also, polymerisation or copolymerisation can be carried out in the presence of additives to control polymer or copolymer molecular weights.

The use of hydrogen gas as a means of controlling the average molecular weight of the polymer or copolymer applies generally to the polymerisation process of the present invention. For example, hydrogen can be used to reduce the average molecular weight of polymers or copolymers prepared using gas phase, slurry phase, bulk phase or solution phase polymerisation conditions. The quantity of hydrogen gas to be employed to give the desired average molecular weight can be determined by simple “trial and error” polymerisation tests.

The polymerisation process of the present invention provides polymers and copolymers, especially ethylene or propylene polymers, at remarkably high productivity (based on the amount of polymer or copolymer produced per unit weight of complex employed in the catalyst system). This means that relatively very small quantities of transition metal complex are consumed in commercial processes using the process of the present invention. It also means that when the polymerisation process of the present invention is operated under polymer recovery conditions that do not employ a catalyst separation step, thus leaving the catalyst, or residues thereof, in the polymer (e.g. as occurs in most commercial slurry and gas phase polymerisation processes), the amount of transition metal complex in the produced polymer can be very small.

Slurry phase polymerisation conditions or gas phase polymerisation conditions are particularly useful for the production of high or low density grades of polyethylene, and polypropylene. In these processes the polymerisation conditions can be batch, continuous or semi-continuous. Furthermore, one or more reactors may be used, e.g. from two to five reactors in series. Different reaction conditions, such as different temperatures or hydrogen concentrations may be employed in the different reactors. In the slurry phase process and the gas phase process, the catalyst is generally metered and transferred into the polymerisation zone in the form of a particulate solid either as a dry powder (e.g. with an inert gas) or as a slurry. This solid can be, for example, a solid catalyst system formed from the one or more of complexes of the invention and an activator with or without other types of catalysts, or can be the solid catalyst alone with or without other types of catalysts. In the latter situation, the activator can be fed to the polymerisation zone, for example as a solution, separately from or together with the solid catalyst. Preferably the catalyst system or the transition metal complex component of the catalyst system employed in the slurry polymerisation and gas phase polymerisation is supported on one or more support materials. Most preferably the catalyst system is supported on the support material prior to its introduction into the polymerisation zone. Suitable support materials are, for example, silica, alumina, zirconia, talc, kieselguhr, or magnesia. Impregnation of the support material can be carried out by conventional techniques, for example, by forming a solution or suspension of the catalyst components in a suitable diluent or solvent, and slurrying the support material therewith. The support material thus impregnated with catalyst can then be separated from the diluent for example, by filtration or evaporation techniques. Once the polymer product is discharged from the reactor, any associated and absorbed hydrocarbons are substantially removed, or degassed, from the polymer by, for example, pressure let-down or gas purging using fresh or recycled steam, nitrogen or light hydrocarbons (such as ethylene). Recovered gaseous or liquid hydrocarbons may be recycled to the polymerisation zone.

In the slurry phase polymerisation process the solid particles of catalyst, or supported catalyst, are fed to a polymerisation zone either as dry powder or as a slurry in the polymerisation diluent. The polymerisation diluent is compatible with the polymer(s) and catalyst(s), and may be an alkane such as hexane, heptane, isobutane, or a mixture of hydrocarbons or paraffins. Preferably the particles are fed to a polymerisation zone as a suspension in the polymerisation diluent. The polymerisation zone can be, for example, an autoclave or similar reaction vessel, or a continuous loop reactor, e.g. of the type well known in the manufacture of polyethylene by the Phillips Process. When the polymerisation process of the present invention is carried out under slurry conditions the polymerisation is preferably carried out at a temperature above 0° C., most preferably above 15° C. The polymerisation temperature is preferably maintained below the temperature at which the polymer commences to soften or sinter in the presence of the polymerisation diluent. If the temperature is allowed to go above the latter temperature, fouling of the reactor can occur. Adjustment of the polymerisation within these defined temperature ranges can provide a useful means of controlling the average molecular weight of the produced polymer. A further useful means of controlling the molecular weight is to conduct the polymerisation in the presence of hydrogen gas which acts as chain transfer agent. Generally, the higher the concentration of hydrogen employed, the lower the average molecular weight of the produced polymer.

In bulk polymerisation processes, liquid monomer such as propylene is used as the polymerisation medium.

Methods for operating gas phase polymerisation processes are well known in the art. Such methods generally involve agitating (e.g. by stirring, vibrating or fluidising) a bed of catalyst, or a bed of the target polymer (i.e. polymer having the same or similar physical properties to that which it is desired to make in the polymerisation process) containing a catalyst, and feeding thereto a stream of monomer at least partially in the gaseous phase, under conditions such that at least part of the monomer polymerises in contact with the catalyst in the bed. The bed is generally cooled by the addition of cool gas (e.g. recycled gaseous monomer) and/or volatile liquid (e.g. a volatile inert hydrocarbon, or gaseous monomer which has been condensed to form a liquid). The polymer produced in, and isolated from, gas phase processes forms directly a solid in the polymerisation zone and is free from, or substantially free from liquid. As is well known to those skilled in the art, if any liquid is allowed to enter the polymerisation zone of a gas phase polymerisation process the quantity of liquid in the polymerisation zone is small in relation to the quantity of polymer present. This is in contrast to “solution phase” processes wherein the polymer is formed dissolved in a solvent, and “slurry phase” processes wherein the polymer forms as a suspension in a liquid diluent.

The gas phase process can be operated under batch, semi-batch, or so-called “continuous” conditions. It is preferred to operate under conditions such that monomer is continuously recycled to an agitated polymerisation zone containing polymerisation catalyst, makeup monomer being provided to replace polymerised monomer, and continuously or intermittently withdrawing produced polymer from the polymerisation zone at a rate comparable to the rate of formation of the polymer, fresh catalyst being added to the polymerisation zone to replace the catalyst withdrawn from the polymerisation zone with the produced polymer.

For typical production of impact copolymers, homopolymer formed from the first monomer in a first reactor is reacted with the second monomer in a second reactor. For manufacture of propylene/ethylene impact copolymer in a gas-phase process, propylene is polymerized in a first reactor; reactive polymer transferred to a second reactor in which ethylene or other comonomer is added. The result is an intimate mixture of a isotactic polypropylene chains with chains of a random propylene/ethylene copolymer. A random copolymer typically is produced in a single reactor in which a minor amount of a comonomer (typically ethylene) is added to polymerizing chains of propylene.

Methods for operating gas phase fluidised bed processes for making polyethylene, ethylene copolymers and polypropylene are well known in the art. The process can be operated, for example, in a vertical cylindrical reactor equipped with a perforated distribution plate to support the bed and to distribute the incoming fluidising gas stream through the bed. The fluidising gas circulating through the bed serves to remove the heat of polymerisation from the bed and to supply monomer for polymerisation in the bed. Thus the fluidising gas generally comprises the monomer(s) normally together with some inert gas (e.g. nitrogen or inert hydrocarbons such as methane, ethane, propane, butane, pentane or hexane) and optionally with hydrogen as molecular weight modifier. The hot fluidising gas emerging from the top of the bed is led optionally through a velocity reduction zone (this can be a cylindrical portion of the reactor having a wider diameter) and, if desired, a cyclone and or filters to disentrain fine solid particles from the gas stream. The hot gas is then led to a heat exchanger to remove at least part of the heat of polymerisation. Catalyst is preferably fed continuously or at regular intervals to the bed. At start up of the process, the bed comprises fluidisable polymer which is preferably similar to the target polymer. Polymer is produced continuously within the bed by the polymerisation of the monomer(s). Preferably means are provided to discharge polymer from the bed continuously or at regular intervals to maintain the fluidised bed at the desired height. The process is generally operated at relatively low pressure, for example, at 10 to 50 bars, and at temperatures for example, between 50 and 120° C. The temperature of the bed is maintained below the sintering temperature of the fluidised polymer to avoid problems of agglomeration.

In the gas phase fluidised bed process for polymerisation of olefins the heat evolved by the exothermic polymerisafion reaction is normally removed from the polymerisation zone (i.e. the fluidised bed) by means of the fluidising gas stream as described above. The hot reactor gas emerging from the top of the bed is led through one or more heat exchangers wherein the gas is cooled. The cooled reactor gas, together with any makeup gas, is then recycled to the base of the bed. In the gas phase fluidised bed polymerisation process of the present invention it is desirable to provide additional cooling of the bed (and thereby improve the space time yield of the process) by feeding a volatile liquid to the bed under conditions such that the liquid evaporates in the bed thereby absorbing additional heat of polymerisation from the bed by the “latent heat of evaporation” effect. When the hot recycle gas from the bed enters the heat exchanger, the volatile liquid can condense out. In one embodiment of the present invention the volatile liquid is separated from the recycle gas and reintroduced separately into the bed. Thus, for example, the volatile liquid can be separated and sprayed into the bed. In another embodiment of the present invention the volatile liquid is recycled to the bed with the recycle gas. Thus the volatile liquid can be condensed from the fluidising gas stream emerging from the reactor and can be recycled to the bed with recycle gas, or can be separated from the recycle gas and then returned to the bed.

The method of condensing liquid in the recycle gas stream and returning the mixture of gas and entrained liquid to the bed is described in EPA0089691 and EPA 0241947. It is preferred to reintroduce the condensed liquid into the bed separate from the recycle gas using the process described in our U.S. Pat. No. 5,541,270, the teaching of which is hereby incorporated into this specification.

When using the catalysts of the present invention under gas phase polymerisation conditions, the catalyst, or one or more of the components employed to form the catalyst can, for example, be introduced into the polymerisation reaction zone in liquid form, for example, as a solution in an inert liquid diluent. Thus, for example, the transition metal component, or the activator component, or both of these components can be dissolved or slurried in a liquid diluent and fed to the polymerisation zone. Under these circumstances it is preferred the liquid containing the component(s) is sprayed as fine droplets into the polymerisation zone. The droplet diameter is preferably within the range 1 to 1000 microns. EPA0593083, the teaching of which is hereby incorporated into this specification, discloses a process for introducing a polymerisation catalyst into a gas phase polymerisation. The methods disclosed in EPA0593083 can be suitably employed in the polymerisation process of the present invention if desired.

Upon completion or partial completion of polymerisation or copolymerisation, it is sometimes desired to terminate polymerisation or copolymerisation or at least temporarily deactivate the catalyst or catalyst component of this invention. To terminate or temporarily deactivate the polymerization or copolymerization, the catalyst can be contacted with water, alcohols, acetone, oxygen, or other suitable catalyst deactivators a manner known to persons of skill in the art.

Homopolymerisation of ethylene with the catalysts of the invention may produce so-called “high density” grades of polyethylene. These polymers have relatively high stiffness and are useful for making articles where inherent rigidity is required. Copolymerisation of ethylene with higher 1-olefins (e.g. butene, hexene or octene) can provide a wide variety of copolymers differing in density and in other important physical properties. Particularly important copolymers made by copolymerising ethylene with higher 1-olefins with the catalysts of the invention are the copolymers having a density in the range of 0.91 to 0.93. These copolymers which are generally referred to in the art as linear low density polyethylene, are in many respects similar to the so called low density polyethylene produced by the high pressure free radical catalysed polymerisation of ethylene. Such polymers and copolymers are used extensively in the manufacture of flexible blown film.

Propylene polymers produced by the process of the invention include propylene homopolymer and copolymers of propylene with less than 50 mole % ethylene or other alpha-olefin such as butene-1, pentene-1, 4-methylpentene-1, or hexene-1, or mixtures thereof. Propylene polymers also may include copolymers of propylene with minor amounts of a copolymerizable monomer. Typically, most useful are normallysolid polymers of propylene containing polypropylene crystallinity, random copolymers of propylene with up to about 10 wt. % ethylene, and impact copolymers containing up to about 20 wt. % ethylene or other alpha-olefin. Polypropylene homopolymers may contain a small amount (typically below 2 wt. %) of other monomers to the extent the properties of the homopolymer are not affected significantly.

Propylene polymers may be produced which are normally solid, predominantly isotactic, poly α-olefins. Levels of stereorandom by-products are sufficiently low so that useful products can be obtained without separation thereof. Typically, useful propylene homopolymers show polypropylene crystallinity and have isotactic indices above 90 and many times above 95. Copolymers typically will have lower isotactic indices, typically above 80-85.

Depending upon polymerisation conditions known in the art, propylene polymers with melt flow rates from below 1 to above 1000 may be produced in a reactor. For many applications, polypropylenes with a MFR from 2 to 100 are typical. Some uses such as for melt-blown fibres may use a polymer with an MFR of 500 to 2000.

Peroxide compounds may be added to ethylene or propylene polymers. For ethylene based polymers, peroxides can be used to give crosslinking in the polymer. For the preparation of high MFR propylene polymers, peroxide compounds may be added during extrusion for controlled rheology to increase the melt flow rate of polymer. Peroxide acts to break long polymer chains and has the effect of both increasing MFR and narrowing the molecular weight distribution (Mw/Mn) or polydispersity. A typical reactor polypropylene powder with an MFR of 2 g/10 min. by controlled rheology treatment with peroxide in an extruder may form a polymer with an OR of 20-40 which may correspond for example to a spunbond fibre product. By varying the type, amount of, and process conditions using, peroxide, the final polymer MFR may be controlled as known in the art.

Depending upon the use of the polymer product, minor amounts of additives are typically incorporated into the polymer formulation such as acid scavengers, antioxidants, stabilizers, and the like. Generally, these additives are incorporated at levels of about 25 to 2000 ppm, typically from about 50 to about 1000 ppm, and more typically 400 to 1000 ppm, based on the polymer.

In use, polymers or copolymers made according to the invention in the form of a powder are conventionally compounded into pellets. Examples of uses for polymer compositions made according to the invention include use to form fibres, extruded films, tapes, spunbonded webs, moulded or thermoformed products, and the like. The polymers may be blown into films, or may be used for making a variety of moulded or extruded articles such as pipes, and containers such as bottles or drums. Specific additive packages for each application may be selected as known in the art. Examples of supplemental additives include slip agents, antiblocks, antistats, mould release agents, primary and secondary antioxidants, clarifiers, nucleants, uv stabilizers, and the like. Classes of additives are well known in the art and include phosphite antioxidants, hydroxylamine (such as N,N-dialkyl hydroxylamine) and amine oxide (such as dialkyl methyl amine oxide) antioxidants, hindered amine light (uv) stabilizers, phenolic stabilizers, benzofuranone stabilizers, and the like. Various olefin polymer additives are described in U.S. Pat. Nos. 4,318,845, 4,325,863, 4,590,231, 4,668,721, 4,876,300, 5,175,312, 5,276,076, 5,326,802, 5,344,860, 5,596,033, and 5,625,090.

Fillers such as silica, glass fibers, talc, and the like, nucleating agents, and colourants also may be added to the polymer compositions as known by the art.

The present invention is illustrated in the following Examples.

### EXAMPLES

### Example 1

### Preparation of Aldehyde Intermediates (1c) and (2c)

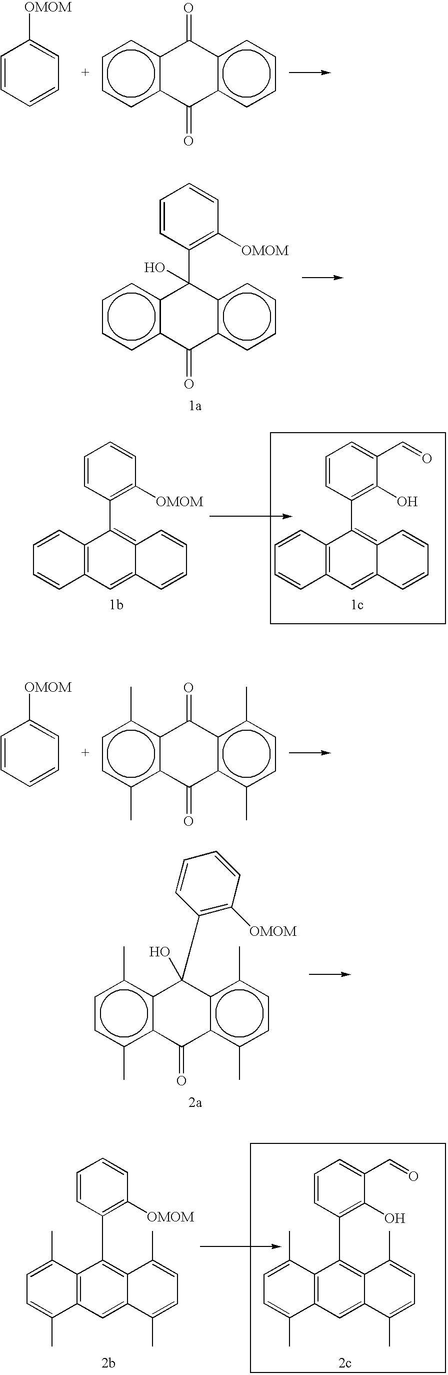 (PhOMOM was made by the method of Yardley, J. P.; -Fletcher., 3rd, H. Synthesis 1976, 244 and 1,4,5,8-tetramethyanthraquinone was made by the method of Carruthers, W. J Chem. Soc. 1963, 5551; Chan, T. L., Mak, T. C. W., Poon, C. D., Wong, H. N. C., Jia, J. H. and Wang, L. L. Tetrahedron 1986, 42(2), 655-661). “MOM” is a standard abbreviation in chemical synthesis for the “methoxymethyl” group.

10-hydroxy-10-(2-(methoxymethoxy)-phenyl)-anthrone (1a).

To a solution of PhOMOM (16 g, 0.116 moles) in 200 mL of ether cooled in water bath was added BuLi (60 mL, 2.5 M, 0.15 moles) and the solution stirred overnight. A precipitate formed after 5-15 minutes. The slurry was added slowly (dropwise) to a slurry of anthraquinone (45 g, excess) in 500 mL of THF at RT, whereupon the solution went a deep green. After addition the solution was stirred for 1 hour then dilute HCl was added to acidify the mix. The slurry was filtered into a separating flask and the organic phase washed with 2×200 mL of distilled water. The solvent was removed by Rotovap and the recovered solids slurried in 400 mL of THF (˜10 ml/g of product). The excess anthraquinone was removed by filtration and the solids washed with 50 ml of THF. The THF was removed on a Rotovap and the solids slurried in a minimum of MeOH and filtered to remove most of the coloured material. The dried solids were recrystallised from hot toluene. A second crop of crystals were recovered from the filtrates by removing the solvent, extracting with THF, filtering, drying and recrystallising from hot toluene. Clear colourless crystals were obtained with a yield of 90.5%. The same procedure was followed reacting the lithium salt with MgBr₂ to form the Grignard reagent. ¹H NMR (400 MHz, CDCl₃) δ 2.565 (s, 3H, —OMe), 2.802 (s, 1H, —OH), 4.470 (s, 2H, —OCH₂), 6.785 (dd, 1H, J=7.8 & 1.1, Ph-H), 7.168 (dt, 1H, J=7.6 & 1.1, Ph-H), 7.246 (dt, 1H, J=7.8 & 1.7, Ph-H), 7.398 (dt, 2H, J=7.4 & 1.4, Anth-H), 7.440 (dd, 2H, J=7.3 & 1.2, Anth-H), 7.502 (dt, 2H, J=7.5 & 1.4, Anth-H), 8.252 (dd, 2H, J=7.6 & 1.1, Anth-H), 8.322 (dd, 1H, J=7.7 & 1.7, Ph-H). ¹³C{¹H} NMR (100 MHz, CDCl₁₃) δ 184.24,151.93, 146.85, 133.84, 133.48, 130.49, 129.11, 127.94, 127.80, 126.24, 125.73, 121.73, 113.51,92.50,70.84, 55.00. EIMS (m/z): M⁺(%) 346(5), 316(15), 314(15), 301(5), 298(5), 285(35), 284(100), 255(95), 209(50), 152(40), 151(50). C₂₂H₁₈O₄ (346.39): Calc. C 76.29, H 5.24; Found C 76.42, H 5.12.

9(2-methoxymethoxy-phenyl)-anthracene (1b).

To a suspension of la (20 g, 57.7 mmoles) in 900 mL of 50/50 H₂O/HOAc was added ZnCl₂ (3.9 g, 28.9 mmoles) followed by Zn (20 g, excess) and the suspension heated to 60° C. overnight (with effective stirring the reaction is finished after about 4 hours). The suspension was cooled and diluted with 2 litres of distilled water and stirred for 30 minutes then allowed to settle. The majority of the water was decanted, 200 mL of toluene added to dissolve the product and the solution filtered to remove unreacted Zn. The aqueous phase was separated and the organic phase washed with 2×200 mL of distilled water. The toluene was removed on a Rotovap. The solids were slurried in a minimum of methanol, filtered and dried. The impure material was recrystallised from a minimum of hot MeOH/toluene 80/20. A pale yellow crystalline solid was obtained, with a yield of 90.2%.

¹H NMR (400 MHz, CDCl₃) δ 3.05 (s, 3H, —OMe), 4.919 (s, 2H, —OCH₂), 7.25-7.60 (m, 8H, Anth-H & Ph-H), 7.684 (d, 2H, J=8.8 Hz, Anth-H), 8.062 (d, 2H, J=8.6 Hz, Anth-H), 8.51 (s, 1H, Anth-H) ¹³C{¹H} NMR (100 MHz, CDCl₃) δ 155.42, 133.67, 132.88, 131.36, 130.33, 129.27, 128.34, 126.73, 126.50, 125.19, 125.00, 121.97, 115.20, 94.12, 55.76. EIMS (m/z): M+(%) 314(65), 282(30), 269(40), 268(50), 239(50), 57(50), 55(40), 45(100). C₂₂H₁₈O₂ (314.39): Calc. C 84.05, H 5.77; Found C 84.30, H 5.71.

3(9-anthryl)-2-hydro-benzaldehyde [3-(9-anthryl)-saligylaldehyde] (1c).

To a slurry of 1b (5.57 g, 17.72 mmoles) in DME (20 mL) was added BuLi (9.2 mL, 2.5 M, 23 mmoles) and the slurry stirred for 4 hours. The slurry was cooled to −78° C., in dry ice/acetone bath, and DMF (5 ml, excess) was added. The mixture was allowed to warm to room temperature and then stirred for 1 hour. The reaction mixture was deactivated by addition of dilute HCl then 100 mL of distilled water. The precipitated product was collected by filtration and washed with water. The crude product was dissolved in 50 mL of THF and 50 mL of 5 M HCl added. The slurry was refluxed for 3 hours, cooled and diluted with 100 mL of distilled water. The crude product was collected by filtration, washed with water, slurried with a minimum amount of methanol, filtered and washed with a small portion of cold methanol, then dried under vacuum. The yellow solid was >99% pure and was used without further purification. Yield was 89.9%. Recrystallisation from hot toluene gave analytically pure material.

¹H NMR (250 MHz, CDCl₃) δ 7.27 (t, 1H, J=7.51 Hz, PhH), 7.35-7.51 (m, 4H, Anth-H), 7.55-7.65 (m, 3H, Anth-H & Ph-H), 8.80 (dd, 1H, J=7.7 & 1.7 Hz, Ph-H), 8.08 (d, 2H, J=8.4 Hz, Anth-H), 8.56 (s, 1H, Anth-H)10.08 (s, 1H, CHO), 11.18 (s, 1H, OH).

10-hydroxy-10-(2-methoxymethoxy-phenyl)-1,4,5,8-tetramethylanthrone (2a).

The same procedure as for 1a was used, but with 1,4,5,8-tetramethylanthraquinone. Yield was 85%. 1,4,5,8tetramethyanthraquinone was made by the method of Carruthers, W. J. Chem. Soc. 1963, 5551; Chan, T. L., Mak, T. C. W., Poon, C. D., Wong, H. N. C., Jia, J. H. and Wang, L. L. Tetrahedron 1986, 42(2), 655-661).

¹H NMR (400 MHz, CDCl₃) δ 2.296 (s 1H, —OH), 2.377 (s 6H, —Me), 2.630 (s 3H, —OMe), 2.645 (s, 6H, Me), 4.684 (s, 2H, OCH₂), 6.812 (d 1H, J=8.1 Hz, Ph-H), 7.03-7.05(m, 5H, Anth-H & Ph-H), 7.169(dt 1H, J=8.1 & 1.7 Hz, Ph-H), 8.326 (dd 1H, J=7.9 & 1.7 Hz, Ph-H). ¹³C{¹H} NMR (100 MHz, CDCl₃) δ 192.02, 152.11, 143.71, 135.81, 135.19, 134.99, 132.78, 130.86, 130.46, 128.45, 127.73, 118.75, 113.07, 91.45, 54.89, 22.08, 21.96.

9-(2-methoxymethoxy-phenyl)-1,4,5,8-tetramethyanthracene (2b).

To a slurry of 2a (3 g, 7.45 mmoles) in 20 mL of ether was added LiAlH₄ (0.60 g, 14.91 mmoles) then BF₃.OEt₂ (0.125 mL, 0.15 g, 1.1 mmoles) and the reaction mix refluxed overnight. The slurry was deactivated by slow addition of dilute HCl. The organic phase was washed with 2×20 mL distilled water, dried over MgSO₄, filtered and the solvent removed under vacuum. The crude material was recrystallised from MeOHl/toluene 80/20. Yield was 88.4%

¹H NMR (250 MHz, CDCl₃) δ 1.95 (s, 6H, Me), 2.85 (s, 6H, Me), 4.71 (s, 1H, OH), 6.90-7.26 (m, 7H, Ph-H & Anth-H), 7.42, (dt, 1H, J=7.7 & 1.9 Hz, Ph-H), 8.85 (s, 1H, Anth-H)

2hydroxy-3-(9(1,4,5,8-tetramethylanthryl))-benzaldehyde [3-(9-(1,4,5,8-tetramethylanthryl))-saligylaldehyde] (2c)

(Taken from the method described by Wang, R. X.; You, X. Z.; Meng, Q. J.; Mintz, E. A.; Bu, X. R. Synth. Commun. 1994,24, 1757-1760). To a solution of 2b (2.32 g, 6.53 mmoles) in 20 mL of toluene was added EtMgBr (2.37 mL, 3M, 6.53 mmoles) in THF followed by paraformaldehyde (0.53 g, 16.3 mmoles) and Et₃N (1.5 mL, 1.08 g, 9.8 mmoles). The resulting solution was heated to 80° C. for 4 hours then deactivated with dilute HCl. The organic phase was separated, washed with dilute acid then water (2×20 mL), then dried over Na₂SO₄. The solution was recovered by filtration and the solvent removed on a Rotavap. The crude product was recrystallised from MeOH. Yield was 72%.

¹H NMR (250 MHz, CDCl₃) δ 1.93 (s, 6H, Me), 2.83 (s, 6H, Me), 7.00-7.20 (m, 5H, Anth-H & Ph-H), 7.36 (dd, 1H, J=7.5 & 1.7 Hz, Ph-H), 7.74 (dd, 1H, J=7.7 & 1.8 Hz, Ph-H), 8.8 (s, 1H, H5), 10.04 (s, 1H, CHO), 11.37 (s, 1H, OH).

### Example 2

### Ligand Synthesis

General procedure: ligands were synthesised using the following two-step protocol involving condensation of 2 equivalents of an aldehyde with one equivalent of a diamine, followed by reductive methylation of the intermediate imine compound.
Step (a), Imineformation : A reaction vessel was charged with the appropriate diamine compound (1.2 mmol) dissolved in ethanol (5 mL). To this solution was added a solution /suspension of the appropriate aldehyde (2.4 mmol) in ethanol (5 mL). The reaction vessel was sealed and stirred at 60° C. for at least 18 hours (overnight). The resulting reaction mixture was cooled and any resulting precipitate was isolated as crude product, and purified further by recrystallisation if necessary. If solid product did not precipitate on cooling, solvent was removed by evaporation and the crude residue was purified by recrystallisation or by colurnn chromatography.
Step (b,: Reductive alkylation: The substrate was dissolved /suspended in 1,2-dichloroethane (30 mL) at 0° C. and aqueous formaldehyde solution was added (1.46 mL, 18 mmol of 37%, 12.3 M, 18 equivalents). The reaction mixture was stirred vigorously and sodium triacetoxyborohydride (3.8 g, 18 mmol) was added as a solid in small batches. The reaction mixture was stirred vigorously overnight. On completion, the reaction mixture was poured into a large vessel and water (50 mL) and dichloromethane (20 mL) were added. The reaction mixture was basified to pH=10-11 and was extracted into dichloromethane (3×20 mL). The organic fractions were combined, washed with brine and dried over magnesium sulphate. The mixture was filtered and concentrated in vacuo to afford crude material which was purified by recrystallisation or column chromatography.
   Synthesis of Specific Ligands 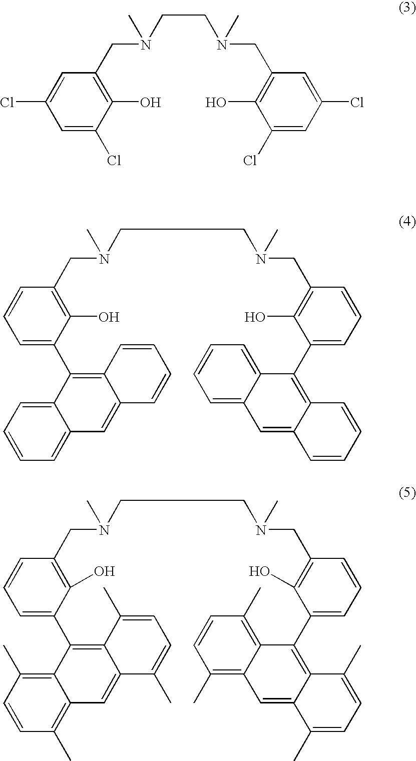
Ligand (3) was prepared from ethylene diamine and 3,5-dichlorosalicylaldehyde (purchased from Aldrich Chem Co.) using the methods described above. The product was found to be the desired compound in good purity by NMR analysis.
Ligand (4) was prepared from ethylene diamine and aldehyde (ic) (prepared according to Example 1) using the method described above. The product was found to be the desired compound in good purity by NMR analysis.
Ligand (5) was prepared from ethylene diamine and aldehyde (2c) (prepared according to example 1) using the method described above. The product was found to be the desired compound in good purity by NMR analysis.

### Examples 3-10

### Ethylene Polymerization

General conditions: toluene was purified by passage through columns containing molecular sieves and a copperbased oxygen scavenger and stored over a sodium mirror. 1-hexene was purified by distillation from sodium and storage over a sodium mirror. MAO (10% Al in toluene) was purchased from Albermarle and used as received. TIBAl (Tri-isobutyl aluminium, 1M in toluene) was purchased from Aldrich and used as received.

### Examples 3 and 4

### Ethylene Homopolymerisation

Into a Schlenk tube was weighed the required amount of the appropriate ligand (Table 1a) and an equimolar quantity of Zr(Bn)₄. Anhydrous toluene was added (20 mL). To the resulting solution was added 500 equivalents of MAO solution. The vessel was then briefly evacuated and refilled with ethylene. The solution was stirred vigorously under a 1 bar ethylene atmosphere for 1 hour. The reaction was quenched by opening the flask to atmosphere followed by addition of acidified methanol. The resulting polymer was isolated by filtration and washed with methanol, then toluene, before drying overnight under reduced pressure at 60° C.

### Example 5

### Ethylene Homopolymerisation

Into a Schlenk tube was weighed the required amount of ligand (4) (Table 1a) and an equimolar quantity of Ti(Bn)₄ The remainder of the procedure is as described for Examples 6 and 7 above.

### Examples 6 and 7

### Ethylene Homopolymerisation

Into a Schlenk tube was weighed the required amount of the appropriate ligand (Table 1a) and an equimolar quantity of ZrBn₄. Anhydrous toluene was added (20 mL). To the solution was added 1 equivalent of [CPh₃][B(C₆F₅)₄] and 10 equivalents of TIBAl (1M in toluene). The vessel was then briefly evacuated and refilled with ethylene. The solution was stirred vigorously under a 1 bar ethylene atmosphere for 1 hour. The reaction was quenched by opening the flask to atmosphere followed by addition of acidified methanol. The resulting polymer was isolated by filtration and washed with methanol, then toluene, before drying overnight under reduced pressure at 60° C.

### Examples 8 and 9

### Co-Polymerisation of Ethylene with 1-hexene

Into a Schlenk tube was weighed the required amount of the appropriate ligand (Table 1a) and an equimolar quantity of Zr(Bn)₄. Anhydrous toluene was added (20 mL) and to the resulting solution was added 500 equivalents of MAO solution. The vessel was then briefly evacuated and refilled with ethylene. Immediately after addition of ethylene, 1-hexene (0.5 mL, ˜2% by volume) was added to the activated catalyst solution. The solution was stirred vigorously under a 1 bar ethylene atmosphere for 1 hour. The reaction was quenched by opening the flask to atmosphere followed by addition of acidified methanol. The resulting polymer was isolated by filtration and washed with methanol, then toluene, before drying overnight under reduced pressure at 60° C.

### Examples 10

### Co-Polymerisation of Ethylene with 1-hexene

Into a Schlenk tube was weighed the required amount of the ligand (3) (Table 1a) and a equimolar quantity of ZrBn₄. Anhydrous toluene was added (20 mL). To the solution was added 1 equivalent of [CPh₃][B(C₆F₅)₄] and 10 equivalents of TIBAl (1M in toluene). The vessel was then briefly evacuated and re-filled with ethylene. Immediately after addition of ethylene, 1-hexene (0.5 mL, ˜2% by volume) was added to the activated catalyst solution. The solution was stirred vigorously under a 1 bar ethylene atmosphere for 1 hour. The reaction was quenched by opening the flask to atmosphere followed by addition of acidified methanol. The resulting polymer was isolated by filtration and washed with methanol, then toluene, before drying overnight under reduced pressure at 60° C.

Polymers from examples 6 to 12 were analysed by GPC and NMR. Results are presented in Table 1b. Note: LCB refers to long chain branches (equal or greater than 6 carbons in length) present in the polymer chains, as measured by ¹³C NMR analysis)

TABLE 1a
Examples 6-13 polymerisation data

| | | Amount | | | | | |
|---|---|---|---|---|---|---|---|
| | | of ligand | | Activator | Scavenger | Yield | Activity |
| Example | Ligand | (mmol) | Metal | (equivalents) | (equivalents) | (g) | (g/mmol · h |
| 3 | 5 | 0.005 | Zr | MAO (500) | — | 2.94 | 588 |
| 4 | 4 | 0.0025 | Zr | MAO (500) | — | 3.23 | 1292 |
| 5 | 4 | 0.005 | Ti | MAO (500) | — | 1.77 | 354 |
| 6 | 3 | 0.01 | Zr | TiBAl/borate | TiBAl (10) | 0.62 | 62 |
| 7 | 4 | 0.0025 | Zr | TiBAl/borate | TiBAl (10) | 0.70 | 279 |
| 8 | 5 | 0.0034 | Zr | MAO (500) | — | 4.00 | 1176 |
| 9 | 4 | 0.0025 | Zr | MAO (500) | — | 1.52 | 609 |
| 10 | 3 | 0.01 | Zr | TiBAl/borate | TiBAl (50) | 0.76 | 76 |

TABLE 1b
Examples 6-13 polymer analysis

| | GPC | | | | | NMR | | |
|---|---|---|---|---|---|---|---|---|
| | Measurements | | | | | Measurements | | |
| Example | Mw | Mn | Mw/Mn | MPk (1) | MPk (2) | Bu/1000 C | LCB/1000 C | iPr ends |
| 3 | 43000 | 8400 | 5.1 | 5500 | 53000 | — | 4.6 | — |
| 4 | 31000 | 4700 | 6.6 | 4100 | 56000 | — | 2.0 | — |
| 5 | insoluble | — | — | — | — | insoluble | — | — |
| 6 | 66000 | 2500 | 26.7 | 1100 | 93000 | — | 0.8 | 2.3 |
| 7 | 51000 | 6800 | 7.6 | 7800 | 99000 | — | 2.1 | — |
| 8 | 53000 | 6900 | 7.7 | 6000 | 102000 | 18.0 | 4.3 | — |
| 9 | 12000 | 3200 | 3.6 | 5300 | — | 12.0 | 2.0 | — |
| 10 | 2600 | 1700 | 1.6 | 2000 | — | 19.2 | — | 0.2 |

### Example 11 to 17

### Propylene Polymerisation

General conditions: Polymerisation grade propylene was further purified by passage through columns containing molecular sieves and a copperbased oxygen scavenger. Toluene was purified in a similar manner and further treated by sparging with dry nitrogen and stored over molecular sieves. MAO (10% Al in toluene) was purchased from Aldrich and used as received. C₆D₆ was dried and stored over a sodium mirror. Borate cocatalyst [CPh₃][B(C₆F₅)₄] was purchased from Boulder Scientific and used as d.

Propylene Polymerisations at 1 Bar, Ambient Temperature

### Example 11

### Homopolymerisation of Propylene Using Ligand 5

An NMR tube was charged with ligand 5 (10 μmol) and a C₆D₆ solution of Zr(benzyl)₄ (1 mL, 10 μmol Zr). Proton NMR analysis indicated formation of a Zr complex. The contents of the NMR tube were placed in a 100 mL Schlenk tube containing toluene (5 ML) and a magnetic stirbar. MAO solution was added (Al/Zr=400) and the solution was exposed to propylene gas (1 bar) for one hour while stirring. The propylene was vented and the contents of the tube were poured into an excess of acidified methanol. Polymer was purified by extraction with hexane. Evaporation of the volatiles yielded 1.6 g of a clear liquid. A summary of the polymerisation and polymer data are given in Table 2 below.

### Example 12

### Homopolymerisation of Propylene Using Ligand 4

Four 8 mL Wheaton vials were each charged with 2.5 μmol of ligand 4, toluene (1 mL) and a magnetic stirbar. A toluene solution of Zr(benzyl)₄ (2.5 μmol Zr) was then added to the ligand solutions, and the mixtures were stirred for 10 min. Toluene solutions of MAO (Al/Zr=375) were then added to each vial (total solution volume in vial=3.5 mL). The vials were exposed to propylene gas (1 bar) for one hour while stirring. The average weight gain of each vial due to formation of PP was 0.123 g. The contents of the four vials were combined into a wide mouth jar and evaporated, yielding 0.76 g of a viscous liquid. A summary of the polymerization and polymer data are given in Table 2 below.

### Example 13

### Homopolymerisation of Propylene Using Ligand 3

Polymerisation was carried out in similar manner to Example 12. The average weight gain of each vial due to formation of PP was 0.213 g. The contents of the vials were combined into a wide mouth jar and allowed to evaporate, yielding 1.04 g of a viscous liquid.

### Example 14

### Homopolymerisation of Propylene Using Ligand 5

Four 8 mL Wheaton vials were each charged with 2.5 micromol of ligand 5, toluene (1 mL) and a magnetic stirbar. A toluene solution of Zr(benzyl)₄ (2.5 μmol Zr) was then added to the ligand solutions, and the mixtures were stirred for 10 min. Toluene solutions of TIBAl (3.4 μmol) were added to each vial for scavenging. Toluene solutions of [CPh₃][B(C₆F₅)₄] (2.5 μmol, B/Zr=1) were then added to each vial (total solution volume in vial=3.5 mL). The vials were exposed to propylene gas (1 bar) for one hour while stirring. The average weight gain of each vial due to formation of PP was 0.320 g. The contents of the four vials were combined into a wide mouth jar and evaporated, yielding 1.24 g of a sticky solid. A summary of the polymerisation and polymer data are given in Table 2 below.

### Example 15

### Homopolymerisation of Propylene Using Ligand 4

Polymerisation was carried out in similar manner to Example 14. The average weight gain of each vial due to formation of PP was 0.409 g. The contents of the vials were combined into a wide mouth jar and evaporated, yielding 1.69 g of a sticky solid.

### Example 16

### Homopolymerisation of Propylene Using Ligand 3

Polymerisation was carried out in similar manner to Example 17. The average weight gain of each vial due to formation of PP was 0.537 g. The contents of the vials were combined into a wide mouth jar and evaporated, yielding 2.24 g of a sticky solid.

Propylene Polymerisations in Liguid Propylene. 50° C.

### Example 17

### Homopolymerisation of Propylene using Ligand 5

A 300 mL Parr reactor was washed, with a dilute toluene solution of TIBAl and then dried with a purge of nitrogen. A 30 wt % solution of MAO in toluene (Al/Zr=1000) was added to the reactor by an addition bomb. A toluene solution (2 mL) of ligand 5 (10 μmol) and Zr(benzyl)₄ (10 μmol) was stirred for 10 min and then loaded into another addition bomb. The precatalyst solution was swept into the reactor with liquid propylene and the reactor was filled with liquid propylene to approx. half its volume. The reactor temperature was brought up to 50° C. and the polymerisation was continued for 1 hour. Afterwards, the propylene was vented from the reactor and the contents were washed into a widemouthed jar and evaporated, yielding 70 g of a cloudy liquid. A portion of the liquid was purified for analysis by extraction into heptane and evaporation.

TABLE 2
Summary of Propylene Polymerisations

| | | | Amount of | | GPC of | |
|---|---|---|---|---|---|---|
| | | | Cocatalyst | Activity | polymer | |
| Example | Ligand | Cocatalyst | (mol/mol_{Zr}) | (gₚₚ/mmol_{catt} · h) | Mₙ | Mw/Mn |
| 11 | 5 | MAO | 400 | 164 | 500 | 1.5 |
| 12 | 4 | MAO | 375 | 30 | 800 | 2.6 |
| 13 | 3 | MAO | 375 | 70 | 400 | 1.5 |
| 14 | 5 | [CPh₃][B(C₆F₅)₄] | 1 | 151 | 600 | 1.7 |
| 15 | 4 | [CPh₃][B(C₆F₅)₄] | 1 | 187 | 1200 | 2.0 |
| 16 | 3 | [CPh₃][B(C₆F₅)₄] | 1 | 238 | 1000 | 2.0 |
| 17 | 5 | MAO | 1000 | 7000 | 500 | 1.5 |

Notes:
EIMS is Electron Impact Mass Spectrometry
DME is 1,2-dimethoxyethane
DMF is dimethylformamide (formdimethylamide)
THF is tetrahydrofuran
TiBAl is triisobutylaluminium
MAO is methylalumoxane

1. A catalyst for the polymerisation of 1-olefins, comprising
(a) a ligand of the formula 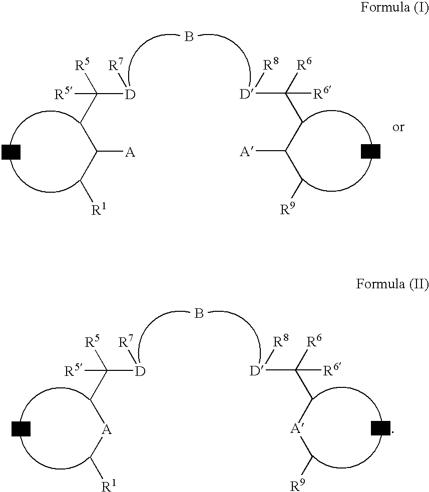
wherein; D and D′ are each independently phosphorus or nitrogen atoms; Q and Q′ are each independently bridging groups forming part of a ring; B is a bridging group between D and D′; R¹ and R⁹ are each independently a polar group or phenyl, naphthyl, anthryl, phenanthryl, triptycyl or a heteroaromatic ring, any of which may be further substituted; R⁵ to R⁵ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent R′ groups may be joined together to form a ring; in the case of Formula (I), A and A′ are independently OH, O⁻, SH, S⁻, NR″H, R″N, PR″H or R″P⁻; and in the case of formula (II) A and A′ are independently NH, N⁻, PH or P⁻, where R″ is defined as for groups R⁵ to R⁹ above; and R⁵ and R⁵′, R⁶ and R^{6′} or R⁷ and R⁸ may be joined together to form a ring;
(b) a source of transition metal from Group 3 to 10 of the Periodic Table or a lanthanide metal and optionally
(c) an activator.

2. A catalyst as claimed in claim 1 wherein the polar group is selected from fluorine, chlorine, bromine or iodine, OMe, NO₂, or SiR′₃ where R′ is as defined in claim 1.

3. A catalyst as claimed in claim 1 wherein the polar group is selected from an atom or group connected through B, C, N, O, F, Al, Si, P, S, Cl, Ga, Ge, As, Se, Br, In, Sn, Te, I and Pb, with the proviso that if the atom is a single carbon atom, it bears no substituents other than halogen substituents: and if the atom comprises two or more carbon atoms one of which is directly linked into the ligand, the additional carbon atom(s) “alpha” to the first carbon bear no substituents other than halogen substituents.

4. A catalyst for the polymerisation of 1-olefins, comprising a metal complex having the Formula (Ia) or (IIa) 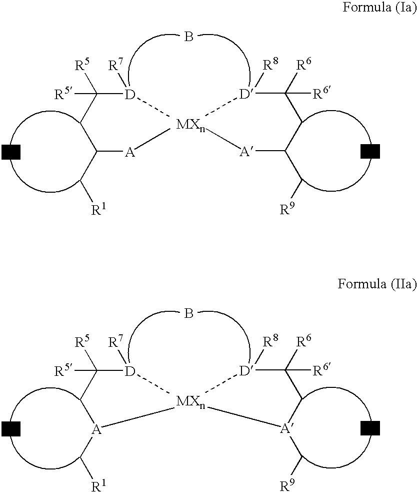
wherein M is a transition metal from Group 3 to 10 of the Periodic Table or a lanthanide; Q and Q′ are each independently bridging groups forming part of a ring; B is a bridging group between D and D′; X represents an atom or group covalently or ionically bonded to M; n is from 1 to 5; D and D′ are each independently nitrogen or phosphorus; R¹ and R⁹ are each independently a polar group or phenyl, naphthyl, anthryl, phenanthryl, or triptycyl or a heteroaromatic ring, any of which may be further substituted; R¹ to R⁹ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups may be joined together to form a ring; in the case of formula (Ia) A and A′ are independently O, S, NR″ or PR″ and are covalently or ionically bonded to M, R″ is as defined as for R⁵ to R⁸ above; in the case of formula (IIa) A and A′ are independently N or P and are covalently or ionically borded to M; R⁵ and R^{5′}, R⁶ and R^{6′} or R⁷ and R⁸ may be joined together to form a ring; and (b) an activator.

5. A catalyst as claimed in claim 4 wherein R¹ and R⁹ are each independently anthryl, phenanthryl or triptycyl only, each of which may optionally be further substituted.

6. A. catalyst as claimed in any one of the preceding claims wherein the ligand has the Formula (M) or (IV) 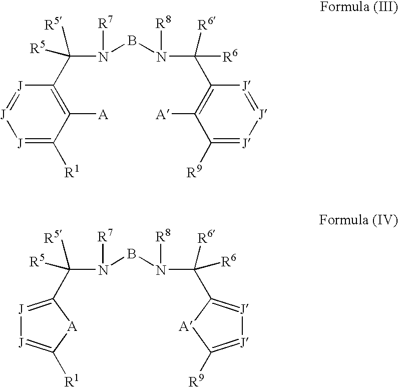
wherein A, A′, B, R¹ and R⁵ to R⁹ are as defined for Formulae (I) and (II) in claim 1, J and J′ are each independently N, P or CR¹⁰, with the proviso that for Formula (I), at least one J and one J′ are CR¹⁰, and where each R¹⁰ is defined as being independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups R¹⁰ may be joined together to form a ring.

7. A catalyst as claimed in any one of the preceding claims wherein the bridging group B is hydrocarbyl, heterohydrocarbyl, aromatic, heteroaromatic, ferrocenyl or comprises NR′, PR′ or SiR′₂ where in each case R′ is independently selected from hydrogen, halogen, hydrocarbyl, substituted hydrocarbyl, heterohydrocarbyl and substituted heterohydrocarbyl.

8. A catalyst as claimed in any one of the preceding claims wherein the bridging group B comprises one of the following structures:

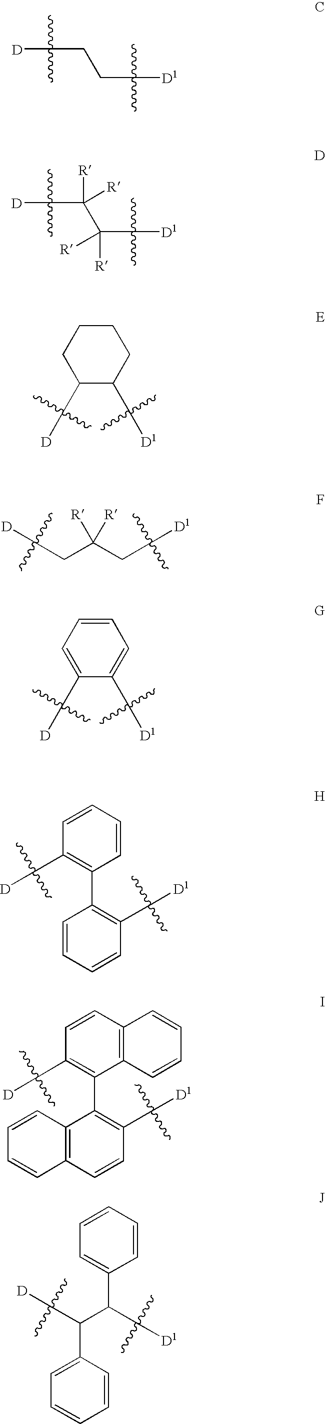

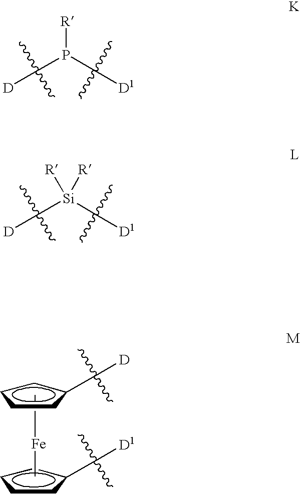

9. A catalyst as claimed in claim 8 wherein D and D¹ are both nitrogen.

10. A catalyst as claimed any one of the preceding claims wherein the ligand has the Formula (V) 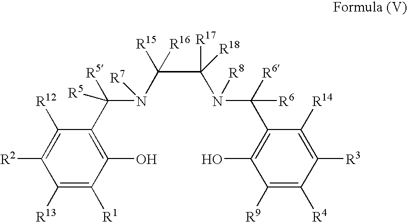
wherein R² to R⁴ and R¹² to R¹⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups may be joined together to form a ring.

11. A catalyst as claimed in claim 10 wherein the ligand is selected from the following ligands:

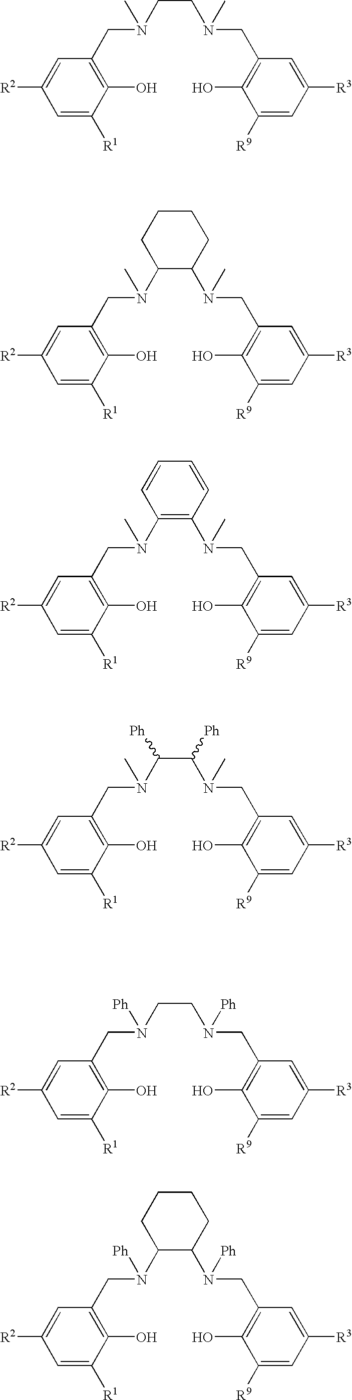

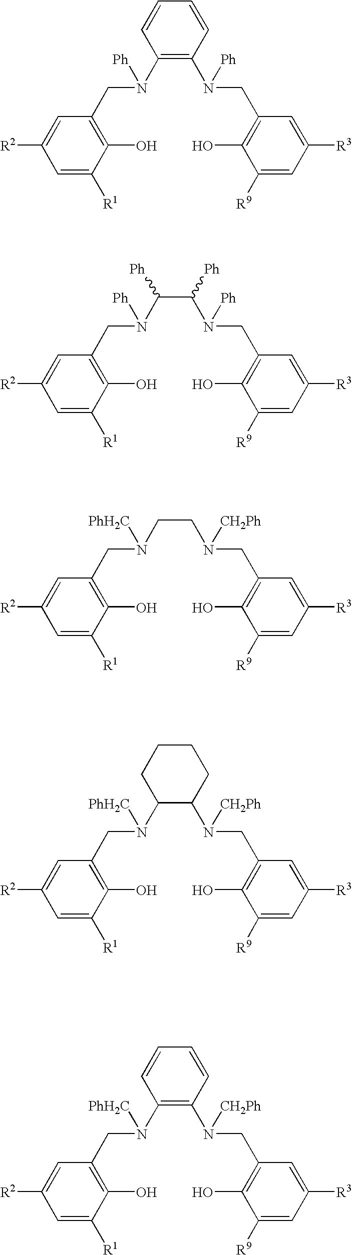

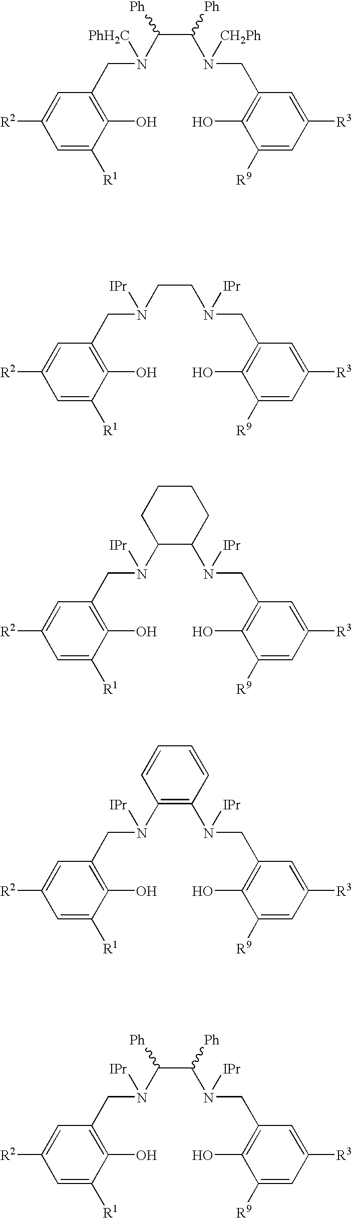

12. A catalyst as claimed in claim 11 wherein R² and R³ are each independently hydrogen, hydrocarbyl, heterohydrocarbyl, halogen, methoxy or NO₂.

13. A catalyst as claimed in claim 11 or 12 wherein R² and R³ are both hydrogen and R¹ and R⁹ are each independently phenyl, naphthyl, anthryl or triptycyl any of which may be further substituted.

14. A catalyst as claimed in any one of the preceding claims wherein the transition metal is selected from Ti[II], Ti[III], Ti[IV], Fe[II], Fe[III], Co[II], Co[III], Ni[II], Cr[II], Cr[III], Mn[II], Mn[III], Mn[IV], Ta[II], Ta[III], Ta[IV], Rh[II], Rh[III], Y[II], Y[III], Sc[II], Sc[III], Ru[II], Ru[III], Ru[IV], Pd[II], Zr[II], Zr[III], Zr[IV], Hf[II], Hf[III], Hf[IV], V[II], V[III], V[IV], Nb[II], Nb[III], Nb[IV] or Nb[V] or lanthanide metal.

15. A catalyst as claimed in any one of the preceding claims wherein R¹ and R⁹ are each independently selected from methoxy, isopropoxy, NO₂, fluorine, chlorine or bromine, or substituted or unsubstituted phenyl, naphthyl, phenanthryl, triptycyl or anthryl, the substituents, if any, being one or more C₁C₄ alkyl groups.

16. A catalyst as claimed in any one of the preceding claims wherein the activator is an alkylalumoxane or a hydrocarbyl boron compound.

17. A process for the polymerisation and copolymerisation of 1-olefins, comprising contacting the monomeric olefin under polymerisation conditions with the polymerisation catalyst or catalyst system claimed in any one of the preceding claims.

18. A process for copolymerising ethylene with one or more other 1-olefins in the presence of the transition metal complex of the present invention optionally in the presence of an activator

19. A compound having the Formula (I) or (II) 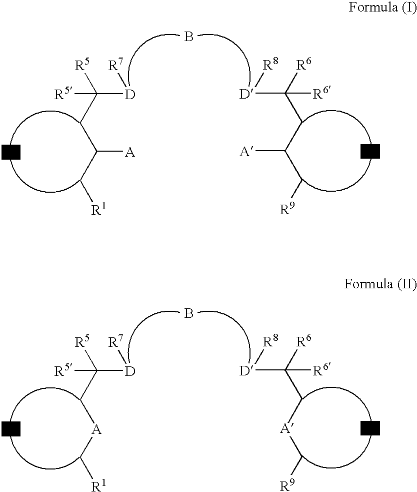
wherein; D and D′ are each independently phosphorus or nitrogen atoms; Q and Q′ are each independently bridging groups forming part of a ring; B is a bridging group between D and D′; wherein R¹ and R⁹ are each independently anthryl, phenanthryl or triptycyl only, each of which may optionally be further substituted; R⁵ to R⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent R′ groups may be joined together to form a ring; in the case of Formula (I), A and A′ are independently OH, O⁻, SH, S⁻, NR″H, R″N⁻, PR″H or R″P⁻; and in the case of formula (II) A and A′ are independently NH, N⁻, PH or P⁻, where R″ is defined as for groups R⁵ to R⁹ above; and R⁵ and R^{5′}, R⁶ and R^{6′} or R⁷ and R⁸ may be joined together to form a ring.

20. A complex having the Formula (Ia) or (IIa) 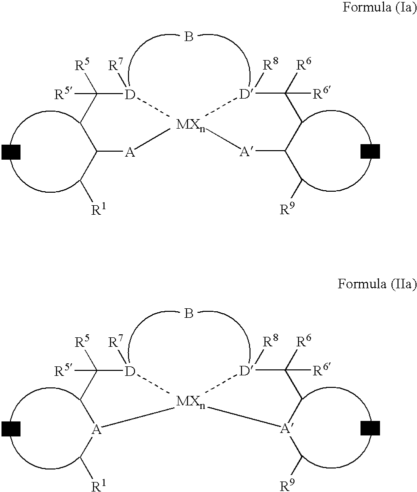
wherein M is a transition metal from Group 3 to 10 of the Periodic Table or a lanthanide; Q and Q′ are each independently bridging groups forming part of a ring; B is a bridging group between D and D′; X represents an atom or group covalently or ionically bonded to M; n is from 1 to 5; D and D′ are each independently nitrogen or phosphorus; R¹ and R⁹ are each independently anthryl, phenanthy, or triptycyl, any of which may be further substituted; R⁵ to R⁸ are each independently selected from hydrogen, halogen, hydrocarbyl, substituted hydrocarbyl, heterohydrocarbyl, substituted heterohydrocarbyl, NR′₂, PR′₂, OR′, SR′ or SiR′₃ where each R′ is independently selected from hydrogen, halogen, hydrocarbyl, substituted hydrocarbyl, heterohydrocarbyl and substituted heterohydrocarbyl, and any adjacent groups may be joined together to form a ring; in the case of formula (Ia) A and A′ are independently O, S, NR″ or PR″ and are covalently or ionically bonded to M, R″ is as defined as for R⁵ to R⁸ above; in the case of formula (IIa) A and A′ are independently N or P and are covalently or ionically bonded to M; R⁵ and R^{5′}, R⁶ and R^{6′} or R⁷ and R⁸ may be joined together to form a ring.
